(19) United States
(12) Patent Application Publication
(10) Pub. No.: US 2013/0085843 A1
(43) Pub. Date: Apr. 4, 2013

(54) GESTURE BASED NAVIGATION TO AUXILIARY CONTENT

(71) Applicants: Matthew G. Dyor, Bellevue, WA (US); Royce A. Levien, Lexington, MA (US); Richard T. Lord, Tacoma, WA (US); Robert W. Lord, Seattle, WA (US); Mark A. Malamud, Seattle, WA (US); Xuedong Huang, Bellevue, WA (US); Marc E. Davis, San Francisco, CA (US)

(72) Inventors: Matthew G. Dyor, Bellevue, WA (US); Royce A. Levien, Lexington, MA (US); Richard T. Lord, Tacoma, WA (US); Robert W. Lord, Seattle, WA (US); Mark A. Malamud, Seattle, WA (US); Xuedong Huang, Bellevue, WA (US); Marc E. Davis, San Francisco, CA (US)

(21) Appl. No.: 13/251,046

(22) Filed: Sep. 30, 2011

(51) Int. Cl. G06F 3/033; G06Q 30/06; G06Q 30/02

(52) U.S. Cl. 705/14.49; 715/863; 705/27.1

(57) ABSTRACT

Methods, systems, and techniques for providing automatic navigation to auxiliary content. Example embodiments provide a Dynamic Gesturelet Generation System (DGGS), which enables users to use a gesture-based user interface and dynamically define any content as a “link” for navigating to other content. In overview, the DGGS allows a user to use a gesture-based user interface to indicate some portion of content that is being presented on a presentation device associated with the user. This indicated portion is then used as a dynamic “link” (without necessitating a link being embedded in the underlying content) by the DGGS to navigate to other content or for other purposes. This dynamic cross-reference to other content is termed a “gesturelet.” The DGGS determines, based upon this gesturelet what content to present next to the user and then presents it accordingly.

### TECHNICAL FIELD

The present disclosure relates to methods, techniques, and systems for providing a gesture-based user interface to users and, in particular, to methods, techniques, and systems for providing automatic navigation to auxiliary content.

### BACKGROUND

As massive amounts of information continue to become progressively more available to users connected via a network, such as the Internet, a company intranet, or a proprietary network, it is becoming increasingly more difficult for a user to find particular information that is relevant, such as for a task, information discovery, or for some other purpose. Typically, a user invokes one or more search engines and provides them with keywords that are meant to cause the search engine to return results that are relevant because they contain the same or similar keywords to the ones submitted by the user. Often, the user iterates using this process until he or she believes that the results returned are sufficiently close to what is desired. The better the user understands or knows what he or she is looking for, often the more relevant the results. Thus, such tools can often be frustrating when employed for information discovery where the user may or may not know much about the topic at hand.

Different search engines and search technology have been developed to increase the precision and correctness of search results returned, including arming such tools with the ability to add useful additional search terms (e.g., synonyms), rephrase queries, and take into account document related information such as whether a user-specified keyword appears in a particular position in a document. In addition, search engines that utilize natural language processing capabilities have been developed.

In addition, it has becoming increasingly more difficult for a user to navigate the information and remember what information was visited, even if the user knows what he or she is looking for. Although bookmarks available in some client applications (such as a web browser) provide an easy way for a user to return to a known location (e.g., web page), they do not provide a dynamic memory that assists a user from going from one display or document to another, and then to another. Some applications provide “hyperlinks,” which are cross-references to other information, typically a document or a portion of a document. These hyperlink cross-references are typically selectable, and when selected by a user (such as by using an input device such as a mouse, pointer, pen device, etc.), result in the other information being displayed to the user. For example, a user running a web browser that communicates via the World Wide Web network may select a hyperlink displayed on a web page to navigate to another page encoded by the hyperlink. Hyperlinks are typically placed into a document by the document author or creator, and, in any case, are embedded into the electronic representation of the document. When the location of the other information changes, the hyperlink is “broken” until it is updated and/or replaced. In some systems, users can also create such links in a document, which are then stored as part of the document representation.

Even with advancements, searching and navigating the morass of information is often times still a frustrating user experience.

### BRIEF DESCRIPTION OF THE DRAWINGS

FIG. 1A is a block diagram of example use of a gesturelet produced by an example Dynamic Gesturelet Generation System (DGGS) or process.

FIG. 1B is a block diagram of an example environment for using gesturelets produced by an example Dynamic Gesturelet Generation System (DGGS) or process.

FIG. 2A is an example block diagram of components of an example Dynamic Gesturelet Generation System.

FIG. 2B is an example block diagram of further components of the Persistent State Generation Module of an example Dynamic Gesturelet Generation System.

FIG. 2C is an example block diagram of further components of the Input Module of an example Dynamic Gesturelet Generation System.

FIG. 2D is an example block diagram of further components of the Criteria Determination Module of an example Dynamic Gesturelet Generation System.

FIG. 2E is an example block diagram of further components of the Target Content Determination Module of an example Dynamic Gesturelet Generation System.

FIG. 2F is an example block diagram of further components of the Presentation Module of an example Dynamic Gesturelet Generation System.

FIG. 3 is an example flow diagram of example logic for automatically providing navigation to target content.

FIG. 4 is an example flow diagram of example logic illustrating an alternative embodiment for automatically providing navigation to target content.

FIG. 5 is an example flow diagram of example logic illustrating various example embodiments of block 410 of FIG. 4.

FIG. 6 is an example flow diagram of example logic illustrating another embodiment for automatically providing navigation to target content.

FIG. 7 is an example flow diagram of example logic illustrating another embodiment for automatically providing navigation to target content.

FIG. 8 is an example flow diagram of example logic illustrating another embodiment for automatically providing navigation to target content.

FIG. 9 is an example flow diagram of example logic illustrating various example embodiments of block 810 of FIG. 8.

FIG. 10 is an example flow diagram of example logic illustrating another embodiment for automatically providing navigation to target content.

FIG. 11 is an example flow diagram of example logic illustrating various example embodiments of block 1010 of FIG. 10.

FIG. 12 is an example flow diagram of example logic illustrating another embodiment for automatically providing navigation to target content.

FIG. 13 is an example flow diagram of example logic illustrating various example embodiments of block 1210 of FIG. 12.

FIG. 14 is an example flow diagram of example logic illustrating another embodiment for automatically providing navigation to target content.

FIG. 15 is an example flow diagram of example logic illustrating various example embodiments of block 1410 of FIG. 14.

FIG. 16 is an example flow diagram of example logic illustrating various example embodiments of block 302 of FIG. 3.

FIG. 17 is an example flow diagram of example logic illustrating various example embodiments of block 302 of FIG. 3.

FIG. 18 is an example flow diagram of example logic illustrating various example embodiments of block 302 of FIG. 3.

FIG. 19A is an example flow diagram of example logic illustrating various example embodiments of block 304 of FIG. 3.

FIG. 19B is an example flow diagram of example logic illustrating various example embodiments of block 304 of FIG. 3.

FIG. 20A is an example flow diagram of example logic illustrating various example embodiments of block 304 of FIG. 3.

FIG. 20B is an example flow diagram of example logic illustrating various example embodiments of block 304 of FIG. 3.

FIG. 21A is an example flow diagram of example logic illustrating various example embodiments of block 306 of FIG. 3.

FIG. 21B is an example flow diagram of example logic illustrating various example embodiments of block 306 of FIG. 3.

FIG. 21C is an example flow diagram of example logic illustrating various example embodiments of block 306 of FIG. 3.

FIG. 21D is an example flow diagram of example logic illustrating various example embodiments of block 306 of FIG. 3.

FIG. 22A is an example flow diagram of example logic illustrating various example embodiments of block 302 of FIG. 3.

FIG. 22B is an example flow diagram of example logic illustrating various example embodiments of block 302 of FIG. 3.

FIG. 23 is an example flow diagram of example logic illustrating various example embodiments of blocks 302 to 308 of FIG. 3.

FIG. 24 is an example block diagram of a computing system for practicing embodiments of a Dynamic Gesturelet Generation System.

### DETAILED DESCRIPTION

Embodiments described herein provide enhanced computer- and network-based methods, techniques, and systems for providing automatic navigation to auxiliary content. Example embodiments provide a Dynamic Gesturelet Generation System (DGGS), which enables users to use a gesture-based user interface and dynamically define any content as a “link” for navigating to other content. In overview, the DGGS allows a user to use a gesture-based user interface to indicate some portion of content that is being presented on a presentation device associated with the user. This indicated portion is then used as a dynamic “link” (without necessitating a link being embedded in the underlying content) by the DGGS to navigate to other content or for other purposes. This dynamic cross-reference to other content is termed a “gesturelet.” The DGGS determines, based upon this gesturelet what content to present next to the user and then presents it accordingly.

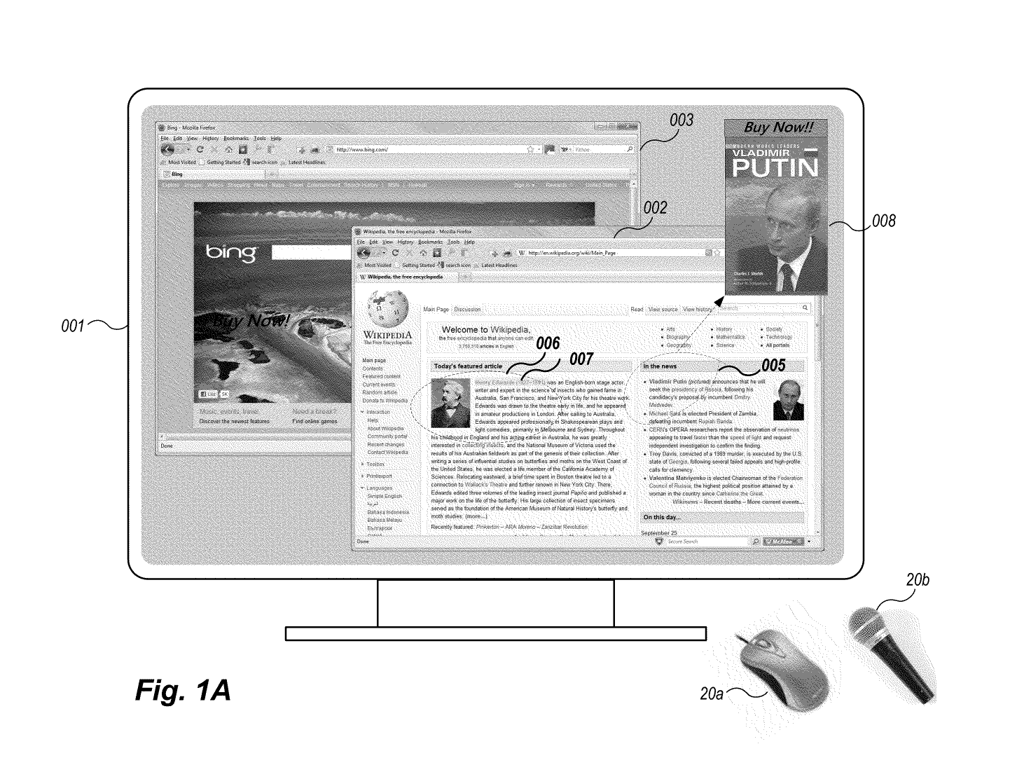

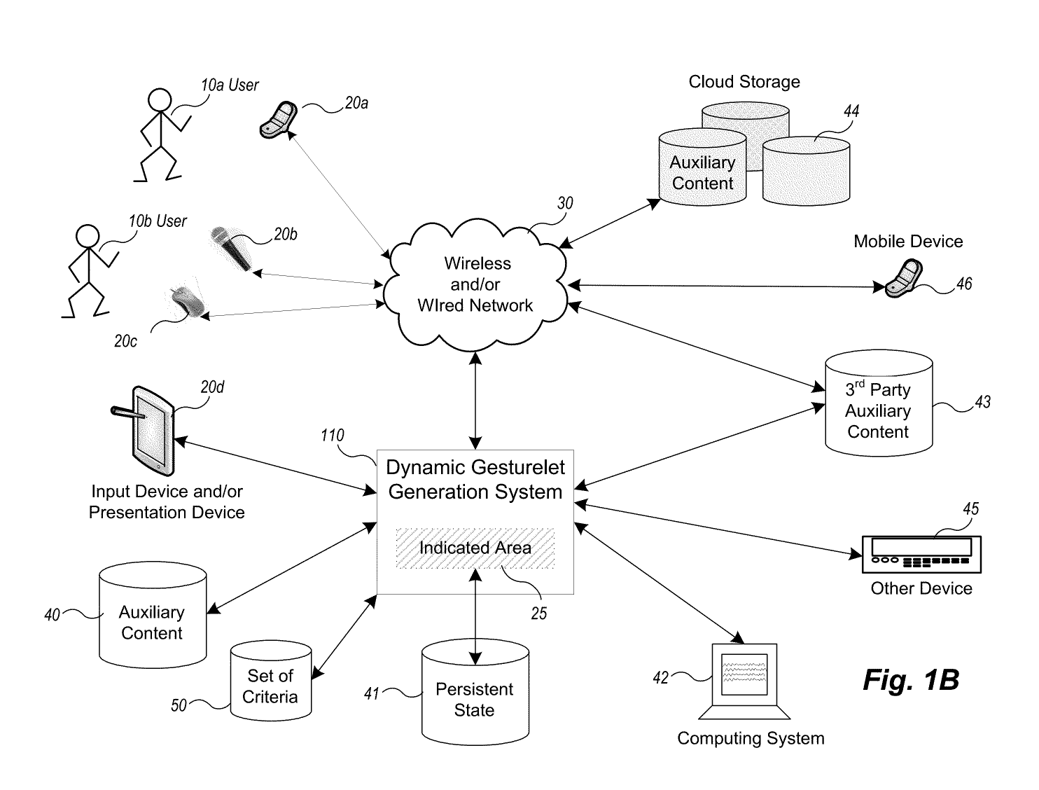

FIG. 1A is a block diagram of example use of a gesturelet produced by an example Dynamic Gesturelet Generation System (DGGS) or process. In FIG. 1A, a presentation device, such as computer display screen 001, is shown presenting two windows with electronic content, window 002 and window 003. The user (not shown) utilizes an input device, such as mouse 20a and/or a microphone 20b, to indicate a gesture (e.g., gesture 005 or gesture 006) to the DGGS. The DGGS, as will be described in detail elsewhere herein, determines to which portion of the underlying electronic content displayed in window 002 the gesture 005 or gesture 007 corresponds. Gesture 005 was created using the mouse device 20a and represents a closed path (shown in red) that is not quite a circle or oval that indicates the user is interested in Vladimir Putin. Gesture 007, as another example, was created using the microphone 20b by directed selection of the image of Henry Edwards along with some text regarding his span of life. The DGGS has highlighted the text to which gesture 007 is determined to correspond. In the example illustrated, the DGGS generates a gesturelet (which may be implemented, for example, using a data structure stored in any type of persistent or non-persistent memory) and associates the gesturelet with auxiliary content. Here, the auxiliary content is shown as an advertised book 008 on Vladimir Putin. The DGGS presents the auxiliary content 008 overlayed on the electronic content presented in window 002.

In some example embodiments of the DGGS, a gesturelet is defined based upon the gesture-based input system. For example, gestures in the form of, for example, circles, ovals, polygons, and/or closed paths may be used to indicate some area of the presented content to be formed into a gesturelet. The gesture may indicate content that is contiguous or non-contiguous. Audio may also be used to indicate some area of the presented content, such as by using a spoken word, phrase, and/or direction. Other embodiments provide additional ways to indicate input by means of a gesture. The DGGS can be fitted to incorporate any technique for providing a gesture that indicates some portion of presented content.

Different techniques may be incorporated when the DGGS presents the auxiliary content associated with a gesturelet. For example, in some embodiments, the DGGS presents the auxiliary content overlaying the initial content. This may be presented in an animated fashion where the auxiliary content “moves into place” from one side of a presentation device. In other examples, the auxiliary content may be placed in another window, pane, frame, or the like, which may or may not be juxtaposed, overlayed, or just placed in conjunction with to the initial presented content. Other arrangements are of course contemplated.

FIG. 1B is a block diagram of an example environment for using gesturelets produced by an example Dynamic Gesturelet Generation System (DGGS) or process. One or more users 10a, 10b, etc. communicate to the DGGS 110 through one or more networks, for example, wireless and/or wired network 30, by indicating gestures using one or more input devices, for example a mobile device 20a, an audio device such as a microphone 20b, or a pointer device such as mouse 20c or the stylus on table device 20d (or for example, or any other input device, such as a keyboard of a computer device). For the purposes of this description, the nomenclature “*” indicates a wildcard (substitutable letter(s)). Thus, user 20* may indicate a device 20a or a device 20b.

Gesturelets are typically generated (e.g., defined, produced, instantiated, etc.) “on-the-fly” as a user indicates, by means of a gesture, what portion of the presented content is interesting. This allows the DGGS 110 to be nimble in its responses to a user's navigation. For example, if the user is navigating among several web sites, the DGGS 110 may respond with apropos content as it follows a user's navigation. In some embodiments, the DGGS 110 may take into account other criteria in addition to the indicated portion of the presented content in order to determine what to navigate to what to present next.

The DGGS 110 determines the indicated area 25 to which the gesture-based input corresponds, and then, based upon the indicated area 25 and a set of criteria 50, generates a gesturelet and determines auxiliary content to be presented. The set of criteria 50 may be dynamically determined, predetermined, local to the DGGS 110 or stored or supplied externally from the DGGS 110 as described elsewhere. This set of criteria may include a variety of factors, including, for example: context of the indicated portion of the presented content, such as other words, symbols, and/or graphics nearby the indicated portion, the location of the indicated portion in the presented content, syntactic and semantic considerations, etc; attributes of the user, for example, prior search, purchase, and/or navigation history, demographic information, and the like; attributes of the gesture, for example, direction, size, steering, and the like; and other criteria, whether currently defined or defined in the future. In this manner, the DGGS 110 allows navigation to become “personalized” to the user as much as the system is tuned.

The auxiliary content determined by the DGGS 110 may be stored local to the DGGS 110, for example, in auxiliary content data repository 40 associated with a computing system running the DGGS 110, or may be stored or available externally, for example, from another computing system 42, from third party content 43 (e.g., a 3^{rd} party advertising system, external content, a social network, etc.) from auxiliary content stored using cloud storage 44, from another device 45 (such as from a settop box, A/V component, etc.), from a mobile device connected directly or indirectly with the user (e.g., from a device associated with a social network associated with the user, etc.), and/or from other devices or systems not illustrated. Third party content 43 is demonstrated as being communicatively connected to both the DGGS 110 directly and/or through the one or more networks 30. Although not shown, various of the devices and/or systems 42-46 also may be communicatively connected to the DGGS 110 directly or indirectly. The auxiliary content may be any type of content and, for example, may include another document, an image, an audio snippet, an audio visual presentation, an advertisement, an opportunity for commercialization such as a bid, a product offer, a service offer, or a competition, or the like. Once the DGGS 110 determines the auxiliary content to present, the DGGS 110 causes the auxiliary content to be presented on a presentation device (e.g., presentation device 20d) associated with the user.

In some example embodiments of the DGGS 110, a generated gesturelet may be associated with auxiliary content so that the DGGS 110 can determine what to present in response to detection of a selection of the generated gesturelet (e.g., the gesturelet is presented in some manner and a user selects it). The generated gesturelet may have a persistent state which can be stored in a memory, for example, a computer solid state memory or a data repository such as persistent state repository 41. A persistent data repository such as data repository 41 may be a data base, a file, an XML definition, memory, or any other means for storing data comprising the gesturelet. The persistent state 41 of the gesturelet may store an indication of the associated auxiliary content. Basically, an indication to any type of content that can be presented on a presentation device may be stored as part of the persistent state of the gesturelet.

The DGGS 110 illustrated in FIG. 1B may be executing (e.g., running, invoked, or the like) on a client or on a server device or computing system. For example, a client application (e.g., a web application, web browser, other application, etc.) may be executing on one of the presentation devices, such as tablet 20d. In some embodiments, some portion or all of the DGGS 110 components may be executing as part of the client application (for example, downloaded as a plug-in, active-x component, part of a monolithic application, etc.). In other embodiments, some portion or all of the DGGS 110 components may be executing as a server (e.g., server application, server computing system, software as a service, etc.) remotely from the client input and/or presentation devices 20a-d.

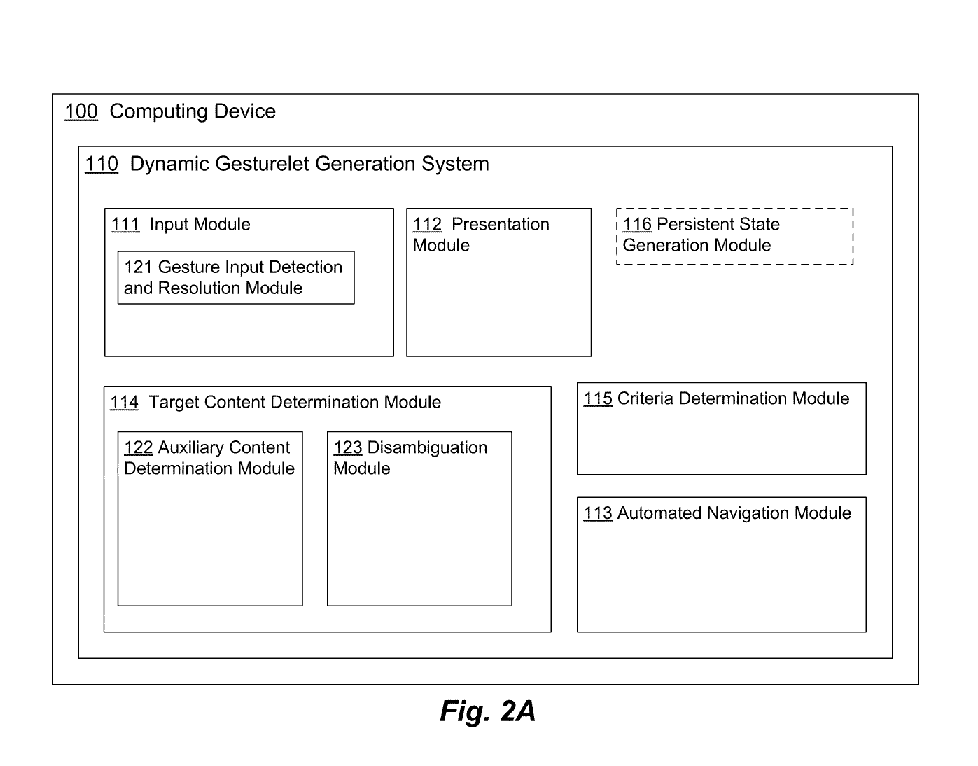

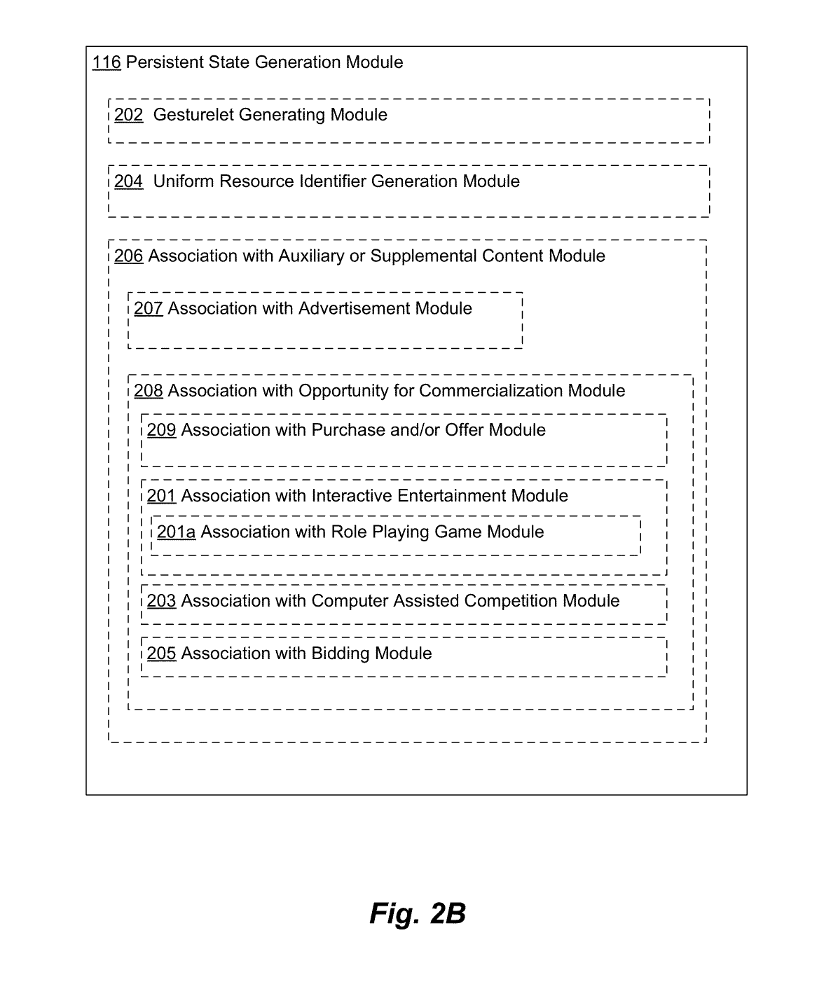

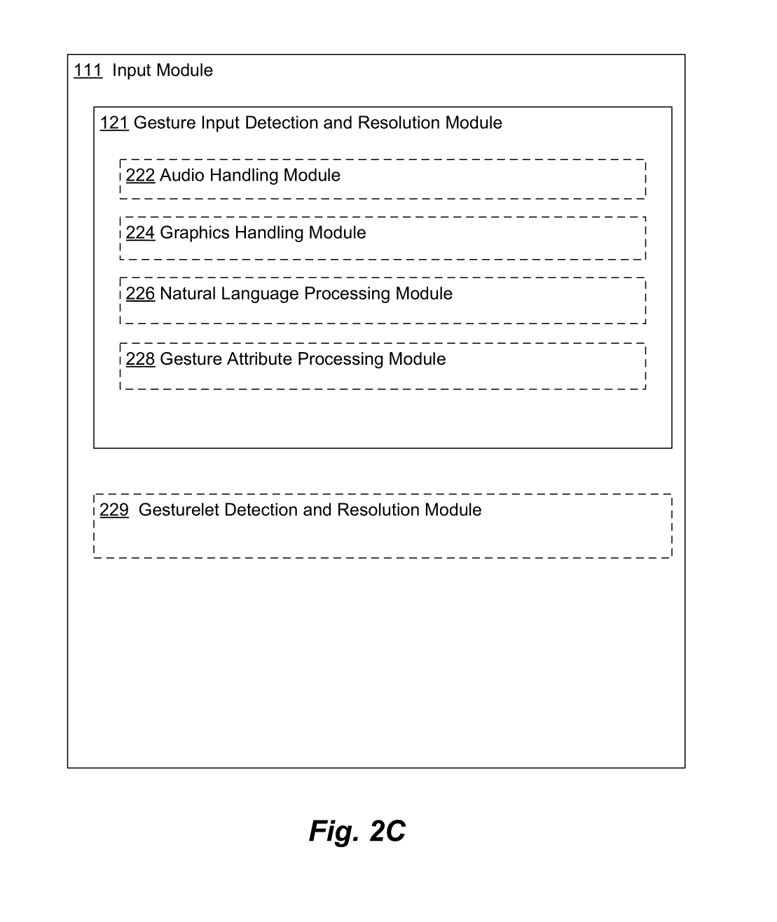

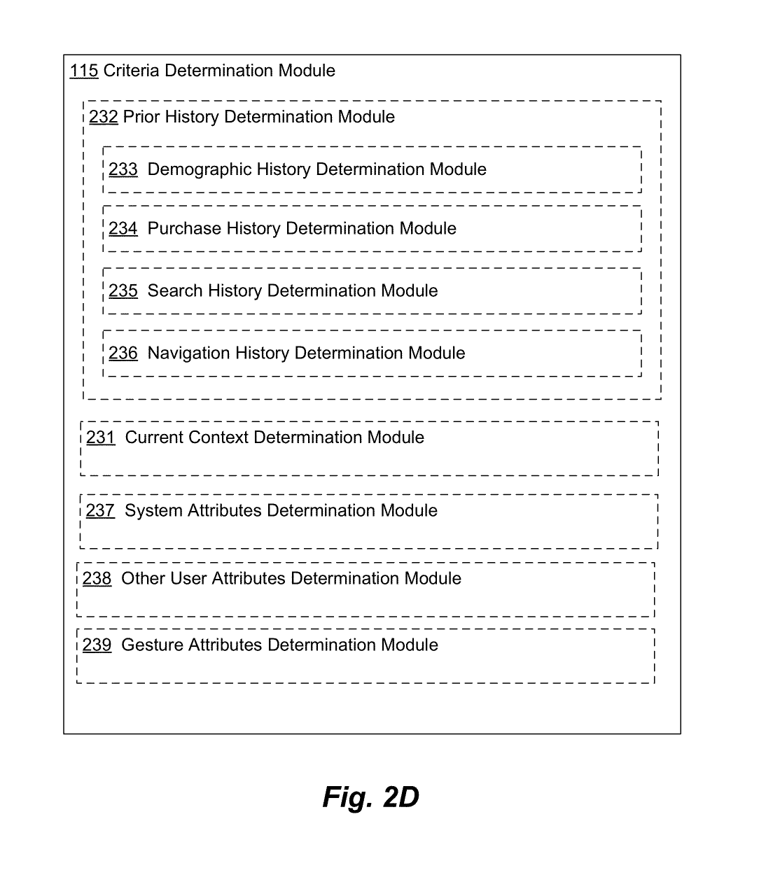

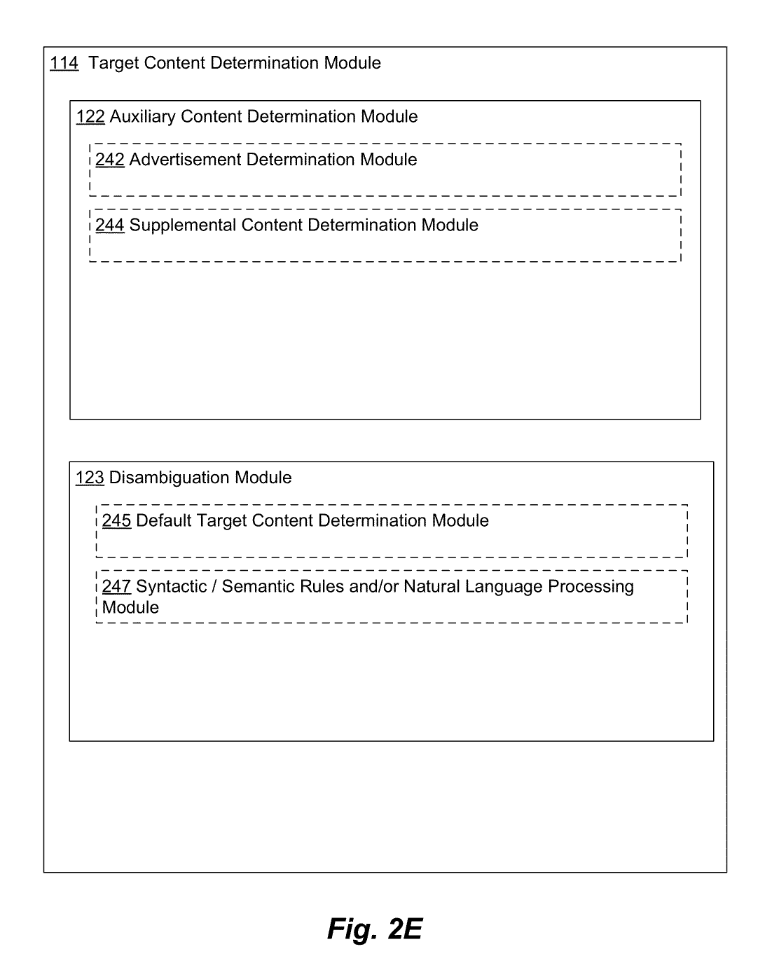

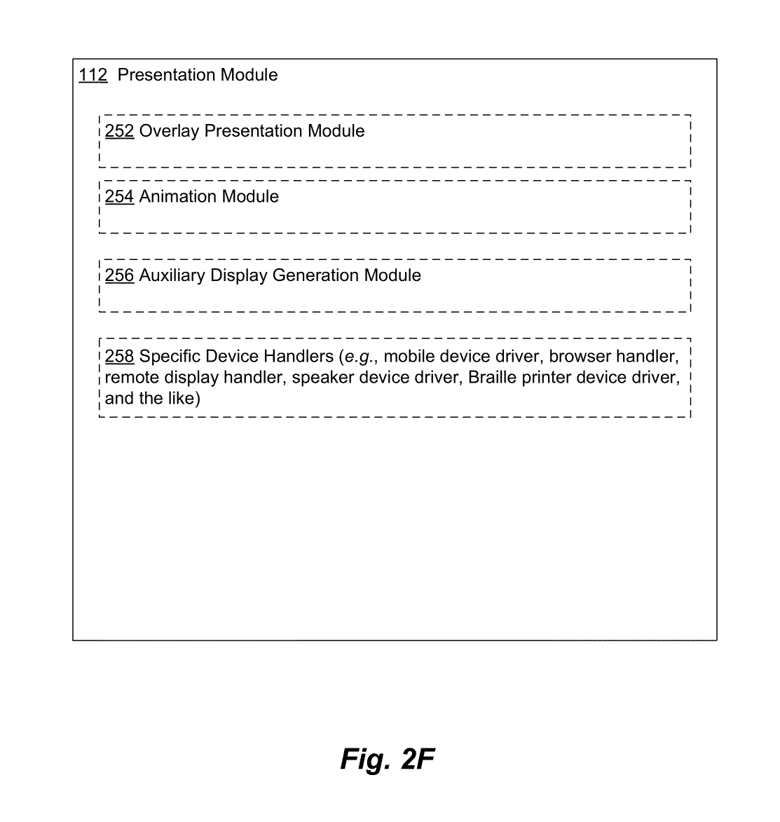

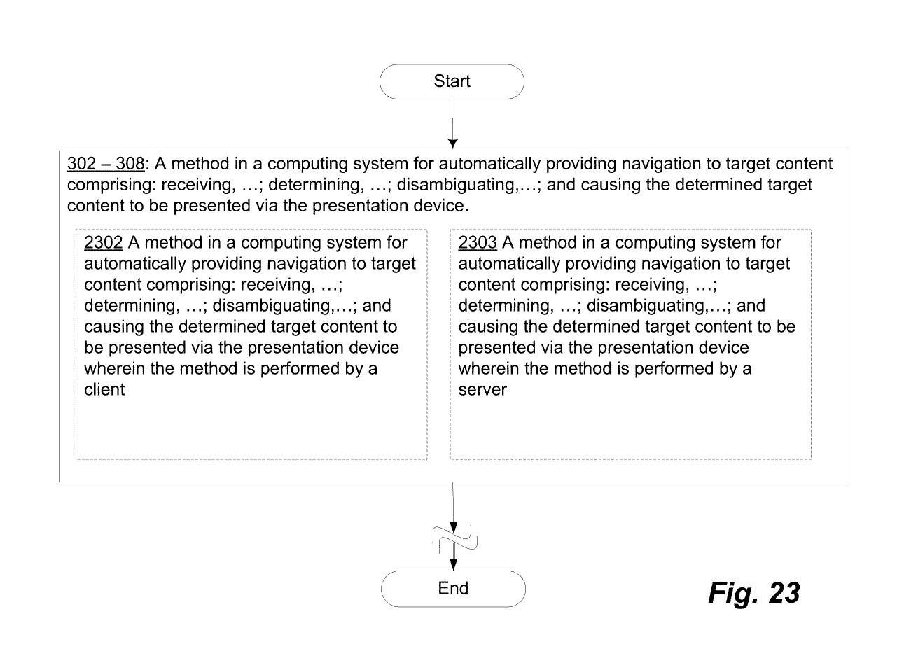

FIG. 2A is an example block diagram of components of an example Dynamic Gesturelet Generation System. In example DGGSes, the DGGS comprises one or more functional components/modules that work together to provide automatic navigation to auxiliary content. For example, a Dynamic Gesturelet Generation System 110 may reside in (e.g., execute thereupon, be stored in, operate with etc.) a computing device 100 programmed with logic to effectuate the purposes of the DGGS 110. As mentioned, a DGGS 110 may be executed client side or server side. For ease of description, the DGGS 110 is described as though it is operating as a server. It is to be understood that equivalent client side modules can be implemented. Moreover, such client side modules need not operate in a client-server environment, as the DGGS 110 may be practiced in a standalone environment. Moreover, the DGGS 10 may be implemented in hardware, software, or firmware, or in some combination. Details of the computing device/system 100 are described below with reference to FIG. 23.

In an example system, a DGGS 110 comprises an input module 111, a presentation module 112, an automated navigation module 113, a target content determination module 114 and a criteria determination module 115. In some example systems, the DGGS 110 also comprises a persistent state generation module 116.

Input module 111 is configured and responsible for determining the gesture and an indication of a portion of the presented electronic content indicated by the gesture. In some example systems, the input module 111 comprises a gesture input detection and resolution module 121 to aid in this process.

Target content determination module 114 is configured and responsible for determining auxiliary content to present based upon an indicated gesture and a set of criteria. The criteria are determined by the criteria determination module 115, and, as described elsewhere, may include factors (e.g., properties, etc.) that relate to the user, the gesture, the electronically presented content, prior history, a social network associated with the user, and the like. An auxiliary content determination module 122 is employed to determined likely auxiliary content. In some cases, for example, when the portion of content indicated by the gesture is ambiguous or not clear by the indicated portion itself, the target content determination module 114 may utilize a disambiguation module 123 to help disambiguate the indicated portion of content. For example, if a gesture has indicated the word “Bill,” the disambiguation module 123 may help distinguish whether the user is likely interested in a person whose name is Bill or a legislative proposal. In addition, based upon the indicated portion of content and the set of criteria more than one auxiliary content item may be identified. If this is the case, then the target content determination module 114 will use the disambiguation module and other logic to select an auxiliary content to present and/or to associate with the gesturelet.

Once target content is identified (e.g., determined, selected, picked, chosen, etc.), the automated navigation module 113 is configured and invoked to cause the presentation module 112 to present the auxiliary content. As described above, the auxiliary content may be presented in a variety of manners, including visual display, audio display, via a Braille printer, etc., and using different techniques, for example, overlays, animation, etc.

In some example systems, the DGGS 110 includes a persistent state generation module 116 that is configured for storing a persistent state of the generated gesturelet.

FIG. 2B is an example block diagram of further components of the Persistent State Generation Module of an example Dynamic Gesturelet Generation System. In some example systems, the persistent state generation module 116 may be configured to include a variety of other modules and/or logic. For example, the persistent state generation module 116 may be configured to include a gesturelet generating module for generating a gesturelet. As noted, a gesturelet may be stored in any appropriate data structure that can store an indicated portion of content or an indicator to the indicated portion and an indication of the auxiliary content associated with the indicated portion of content. In some example systems, a gesturelet is generated using a uniform resource identifier (URI) or uniform resource locator (URL). A uniform resource identifier generation module 204 may be configured to be included in such systems to aid in the generation of URIs that can be configured as gesturelets. In some example systems, as part of generating persistent state for a gesturelet, the persistent state generation module 116 may be configured to include an association with auxiliary or supplemental content module 206 that is configured to associate auxiliary or supplemental content with the persistent state of a gesturelet. The association with auxiliary or supplemental content module 206 may be further configured to include a variety of different modules to aid in this association process. For example, the association with auxiliary or supplemental content module 206 may be configured to include an association with advertisement module 207 to associate the gesturelet with an advertisement and/or may be configured to include an association with opportunity for commercialization module 208 to associate the gesturelet with a commercialization opportunity. In some such systems, the commercialization opportunities may include events such as purchase and/or offers, and the association with opportunity for commercialization module 208 may be further configured to include an association with purchase and/or offer module 209 with logic to aid in associating a purchase and/or an offer with a gesturelet. Other modules and logic may be also configured to be used with the persistent state generation module 116.

FIG. 2C is an example block diagram of further components of the Input Module of an example Dynamic Gesturelet Generation System. In some example systems, the input module 111 may be configured to include a variety of other modules and/or logic. For example, the input module 111 may be configured to include a gesture input detection and resolution module 121 as described with reference to FIG. 2A. The gesture input detection and resolution module 121 may be further configured to include a variety of modules and logic for handling a variety of input devices and systems. For example, gesture input detection and resolution module 121 may be configured to include an audio handling module 222 for handling gesture input by way of audio devices and/or a graphics handling module 224 for handing the association of gestures to graphics in content (such as an icon, image, movie, still, sequence of frames, etc.). In addition, in some example systems, the input module 111 may be configured to include a natural language processing (NLP) module 226. NLP module 226 may be used, for example, to detect whether a gesture is meant to indicate a word, a phrase, a sentence, a paragraph, or some other portion of presented electronic content using techniques such as syntactic and/or semantic analysis of the content. In some example systems, the input module 111 may be configured to include a gesture attribute processing module 228 for handling other aspects of gesture determination such as determining whether a particular gesture is a “steering” gesture that is meant to correct, for example, an initial path indicated by a gesture, a “smudge” which may have its own interpretation, the color of the gesture, for example, if the input device supports the equivalent of a colored “pen” (e.g., pens that allow a user can select blue, black, red, or green), size of a gesture (e.g., whether the gesture draws a thick or thin line, whether the gesture is a small or large circle, and the like), and/or other attributes of a gesture.

Input module 111 also may be configured to include a gesturelet detection and recognition module 229 that is configured to determine (e.g., detect, find out, receive notification of) when a gesturelet has been presented to the system (e.g., by user selection, notification, and so forth) and what the gesturelet is associated with. This information may be used, for example, by the target content determination module 114 to determine what content is associated with the gesturelet in order to cause it to be presented.

Other modules and logic may be also configured to be used with the input module 111.

FIG. 2D is an example block diagram of further components of the Criteria Determination Module of an example Dynamic Gesturelet Generation System. In some example systems, the criteria determination module 115 may be configured to include a variety of other modules and/or logic. For example, the criteria determination module 115 may be configured to include a prior history determination module 232, a system attributes determination module 237, other user attributes determination module 238, a gesture attributes determination module 239, and/or current context determination module 231. In some example systems, the prior history determination module 232 determines (e.g., finds, establishes, selects, realizes, resolves, establishes, etc.) prior histories associated with the user and is configured to include modules/logic to implement such. For example, the prior history determination module 232 may be configured to include a demographic history determination module 233 that is configured to determine demographics (such as age, gender, residence location, citizenship, languages spoken, or the like) associated with the user. The prior history determination module 232 may be configured to include a purchase history determination module 234 that is configured to determine a user's prior purchases. The purchase history may be available electronically, over the network, may be integrated from manual records, or some combination. In some systems, these purchases may be product and/or service purchases. The prior history determination module 232 may be configured to include a search history determination module 235 that is configured to determine a user's prior searches. Such records may be stored locally with the DGGS 110 or may be available over the network or using a third party service, etc. The prior history determination module 232 also may be configured to include a navigation history determination module 236 that is configured to keep track of and/or determine how a user navigates through his or her computing system so that the DGGS 110 can determine aspects such as navigation preferences, commonly visited content (for example, commonly visited websites or bookmarked items), etc.

The criteria determination module 115 may be configured to include a system attributes determination module 237 that is configured to determine aspects of the “system” that may provide influence or guidance (e.g., may inform) the determination of which auxiliary content is appropriate for the portion of content indicated by a received gesture. These may include aspects of the DGGS 110, aspects of the system that is executing the DGGS (e.g., the computing system 100), aspects of a system associated with the DGGS 110 (e.g., a third party system), network statistics, and/or the like.

The criteria determination module 115 may be configured to include other user attributes determination module 238 that is configured to determine other attributes associated with the user not covered by the prior history determination module 232. For example, a user's social connectivity data may be determined by module 238.

The criteria determination module 115 may be configured to include a gesture attributes determination module 239. The gesture attributes determination module 239 is configured to provide determinations of attributes of the gesture input, similar or different from those described relative to input module 111 and gesture attribute processing module 228 for determining to what content a gesture corresponds. Thus, for example, the gesture attributes determination module 239 may provide information and statistics regarding size, length, shape, color, and/or direction of a gesture.

The criteria determination module 115 may be configured to include a current context determination module 231. The current context determination module 231 is configured to provide determinations of attributes regarding what the user is viewing, the underlying content, context relative to other containing content (if known), whether the gesture has selected a word or phrase that is located with certain areas of presented content (such as the title, abstract, a review, and so forth).

Other modules and logic may be also configured to be used with the criteria determination module 115.

FIG. 2E is an example block diagram of further components of the Target Content Determination Module of an example Dynamic Gesturelet Generation System. In some example systems, the target content determination module 114 may be configured to include a variety of other modules and/or logic. For example, the target content determination module 114 may be configured to include a an auxiliary content determination module 122 and a disambiguation module 123.

In some example systems, the auxiliary content determination module 122 is further configured to provide an advertisement determination module 242. The advertisement determination module 242 may be configured to determine one or more advertisements that can be associated with the current gesturelet. For example, as shown in FIG. 1B, these advertisements may be provided by a variety of sources including from local storage, over a network (e.g., wide area network such as the Internet, a local area network, a proprietary network, an Intranet, or the like), from a known source provider, from third party content (available, for example from cloud storage or from the provider's repositories), and the like. In some systems, a third party advertisement provider system is used that is configured to accept queries for advertisements (“ads”) such as using keywords, to output appropriate advertising content.

In some example systems the auxiliary content determination module 122 is further configured to provide a supplemental content determination module 244. The supplemental content determination module 244 may be configured to determine other content that somehow relates to (e.g., associated with, supplements, improves upon, corresponds to, has the opposite meaning from, etc.) the content associated with the gesturelet.

As described with reference to FIG. 2A, the disambiguation module 123 is configured to aid in the selection of auxiliary content when, for example, the meaning of the portion of content indicated by the gesturelet is perhaps unclear and/or when, for example, more than one possibility of auxiliary content is determined by the auxiliary content determination module 122 for possible presentation.

In some example systems, the disambiguation module 123 is configured to include a default target content determination module 245. The target content determination module 245 is configured to provide “default” auxiliary content that relates to a gesturelet. This may be helpful, for example, when the auxiliary content determination module 122 does not return useful (or any) results. In some example systems, the default auxiliary content may be presented to the user for possible selection, alone or in addition to results determined by the auxiliary content determination module 122.

In some example systems, the disambiguation module 123 is configured to include a syntactic/semantic rules and/or NLP module 247. This module is configured to assist in disambiguating whether particular auxiliary content determined by the auxiliary content determination module 122 actual relates to the portion of content indicated by the gesturelet. This may occur as explained above when a word or phrase (or image) in the gesturelet may have more than one meaning. The DGGS 110 performs a type of “just in time” disambiguation (like late binding) in that the DGGS 110 may not resolve a potentially ambiguous indication of content, as indicated by the gesturelet, until it determines that more than one type of possible auxiliary content was found. Any sort of syntactic and/or semantic processing that is useful to disambiguate words, phrases, text, etc. may be incorporated into module 247.

Other modules and logic may be also configured to be used with the target content determination module 114.

FIG. 2F is an example block diagram of further components of the Presentation Module of an example Dynamic Gesturelet Generation System. In some example systems, the presentation module 112 may be configured to include a variety of other modules and/or logic. For example, the presentation module 112 may be configured to include an overlay presentation module 252 for determined how to present auxiliary content determined by the target content determination module 114 on a presentation device, such as tablet 20d. Overlay presentation module 252 may utilize knowledge of the presentation devices to decide how to integrate the auxiliary content as an “overlay” (e.g., covering up a portion or all of the underlying presented content). For example, when the DGGS 110 is run as a server application that serves web pages to a client side web browser, certain configurations using “html” commands or other tags may be used.

Presentation module 112 also may be configured to include an animation module 254. In some example systems, the auxiliary content may be “moved in” from one side or portion of a presentation device in an animated manner. For example, the auxiliary content may be placed in a pane (e.g., a window, frame, pane, etc., as appropriate to the underlying operating system or application running on the presentation device) that is moved in from one side of the display onto the content previously shown (a form of navigation to the auxiliary content). Other animations can be similarly incorporated.

Presentation module 112 also may be configured to include an auxiliary display generation module 256 for generating a new graphic or audio construct to be presented in conjunction with the content already displayed on the presentation device. In some systems, the new content is presented in a new window, frame, pane, or other auxiliary display construct.

Presentation module 112 also may be configured to include specific device handlers 258, for example device drivers configured to communicate with mobile devices, remote displays, speakers, Braille printers, and/or the like. Other or different presentation device handlers may be similarly incorporated.

Also, other modules and logic may be also configured to be used with the presentation module 112.

Although the techniques of a DGGS are generally applicable to any type of gesture-based system, the phrase “gesture” is used generally to imply any type of physical pointing type of gesture or audio equivalent. In addition, although the examples described herein often refer to online electronic content such as available over a network such as the Internet, the techniques described herein can also be used by a local area network system or in a system without a network. In addition, the concepts and techniques described are applicable to other input and presentation devices. Essentially, the concepts and techniques described are applicable to any environment that supports some type of gesture-based input.

Also, although certain terms are used primarily herein, other terms could be used interchangeably to yield equivalent embodiments and examples. In addition, terms may have alternate spellings which may or may not be explicitly mentioned, and all such variations of terms are intended to be included.

Example embodiments described herein provide applications, tools, data structures and other support to implement a Dynamic Gesturelet Generation System (DGGS) to be used for automatically providing navigation to target content. Other embodiments of the described techniques may be used for other purposes. In the following description, numerous specific details are set forth, such as data formats and code sequences, etc., in order to provide a thorough understanding of the described techniques. The embodiments described also can be practiced without some of the specific details described herein, or with other specific details, such as changes with respect to the ordering of the code flow, different code flows, etc. Thus, the scope of the techniques and/or functions described are not limited by the particular order, selection, or decomposition of steps described with reference to any particular routine.

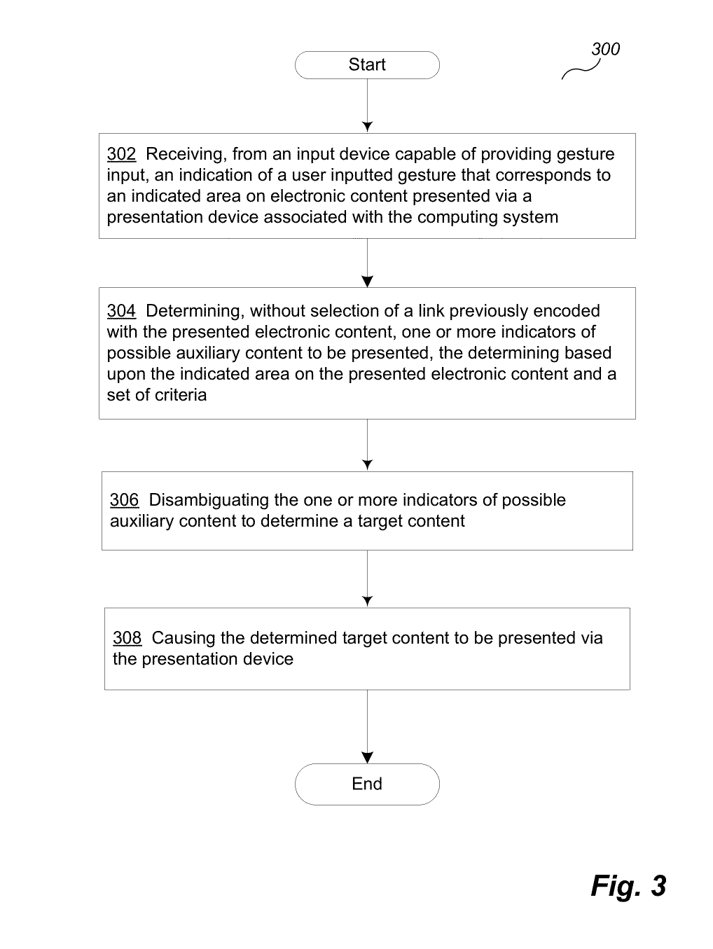

FIGS. 3-23 include example flow diagrams of various example logic that may be used to implement embodiments of a Dynamic Gesturelet Generation System (DGGS). The example logic will be described with respect to the example components of example embodiments of a DGGS as described above with respect to FIGS. 1A-2F. However, it is to be understood that the flows and logic may be executed in a number of other environments, systems, and contexts, and/or in modified versions of those described. In addition, various logic blocks (e.g., operations, events, activities, or the like) may be illustrated in a “box-within-a-box” manner. Such illustrations may indicate that the logic in an internal box may comprise an optional example embodiment of the logic illustrated in one or more (containing) external boxes. However, it is to be understood that internal box logic may be viewed as independent logic separate from any associated external boxes and may be performed in other sequences or concurrently.

FIG. 3 is an example flow diagram of example logic for automatically providing navigation to target content. Operational flow 300 includes several operations. In operation 302, the logic performs receiving, from an input device capable of providing gesture input, an indication of a user inputted gesture that corresponds to an indicated area on electronic content presented via a presentation device associated with the computing system. This logic may be performed, for example, by the input module 111 of the DGGS 110 described with reference to FIG. 2A by receiving (e.g., obtaining, getting, extracting, and so forth), from an input device capable of providing gesture input (e.g., devices 20*), an indication of a user inputted gesture that corresponds to an indicated area (e.g., indicated area 25) on electronic content presented via a presentation device (e.g., 20*) associated with the computing system 100. One or more of the modules provided by the gesture input detection and resolution module 121, including the audio handling module 222, graphics handling module 224, natural language processing module 226, and/or gesture attribute processing module 228 may be used to assist in operation 302.

In operation 304, the logic performs determining, without selection of a link previously encoded with the presented electronic content, one or more indicators of possible auxiliary content to be presented, the determining based upon the indicated area on the presented electronic content and a set of criteria. This logic may be performed, for example, by the target content determination module 114 of the DGGS 110 described with reference to FIG. 2A by determining (e.g., obtaining, eliciting, receiving, designating, etc.) one or more indicators of possible auxiliary content to be presented, the determining based upon the indicated area (e.g., area 25) on the presented electronic content and a set of criteria. The set of criteria is determined, for example, using criteria determination module 115 described with reference to FIGS. 2A and 2D.

In operation 306, the logic performs disambiguating the one or more indicators of possible auxiliary content to determine a target content. This logic may be performed, for example, by the disambiguation module 123 of the DGGS 110 described with reference to FIGS. 2A and 2E. Disambiguating may be necessary when the auxiliary content determination module 122 determines content that rests on the portion of the presented content indicated by indicated area being susceptible to more than one interpretation or when a plurality of possible auxiliary content is determined.

In operation 308, the logic performs causing the determined target content to be presented via the presentation device. This logic may be performed, for example, by the automated navigation module 113 and the presentation module 112 of the DGGS 110 as described in FIGS. 2A and 2B using presentation device 20*.

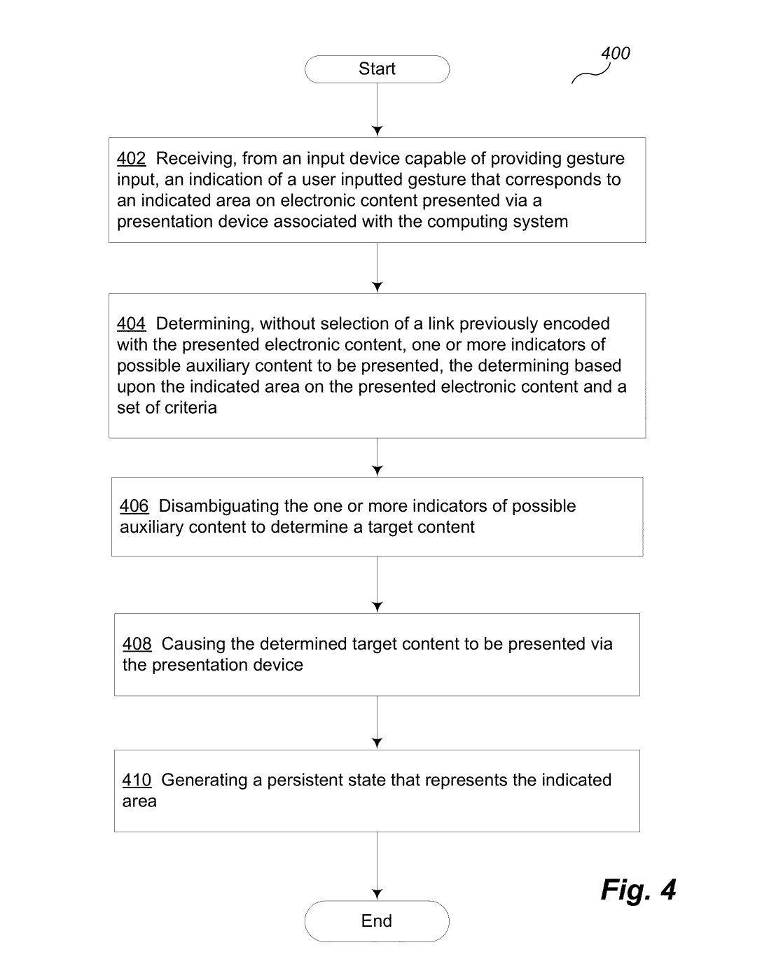

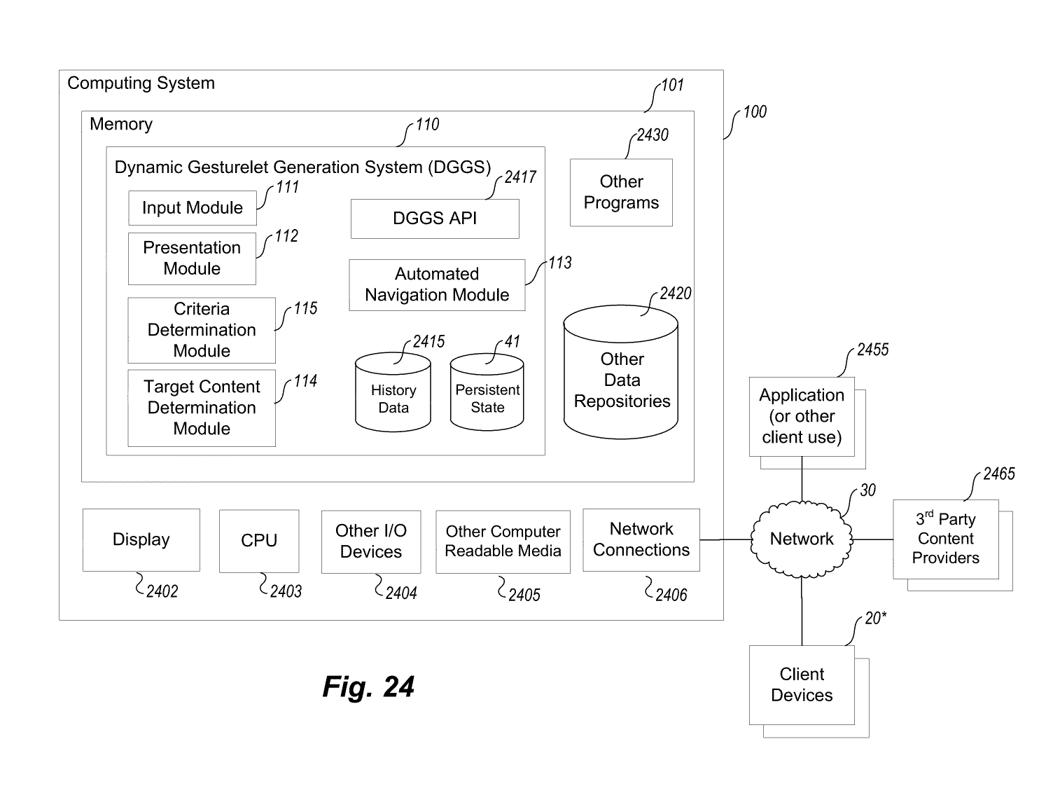

FIG. 4 is an example flow diagram of example logic illustrating an alternative embodiment for automatically providing navigation to target content. The logic of FIG. 4 includes, as a portion, the logic included in FIG. 3. In particular, the logic described by operations 402, 404, 406, and 408 follows that of corresponding operations in FIG. 3. In addition, operational flow 400 includes operation 410 which performs generating a persistent state that represents the indicated area. This logic may be performed, for example, by the persistent state generation module 116 of the DGGS 110 described with reference to FIGS. 2A and 2B by generating a representation of the indicated area (e.g., area 25) in memory (e.g., memory 101 in FIG. 24).

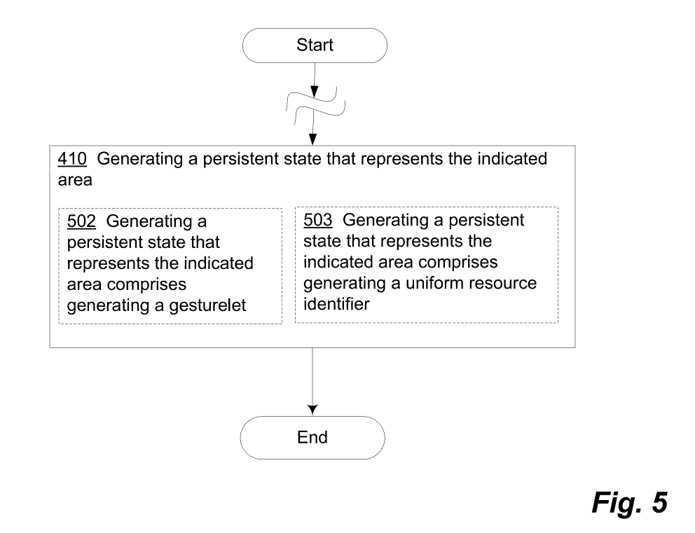

FIG. 5 is an example flow diagram of example logic illustrating various example embodiments of block 410 of FIG. 4. In some embodiments, the logic of operation 410 for generating a persistent state that represents the indicated area may include an operation 502 for generating a gesturelet. As described earlier, a “gesturelet” describes a special (stored) representation based upon a gesture that can be used to recall associated information. Similar to a link, it can be used to navigate to information; however, is created dynamically (e.g., on-the-fly) based upon a gesture (not previously stored link data) and is not embedded into the representation of the presented content. The logic of operation 502 may be performed, for example, by the gesturelet generating module 202 of the persistent state generation module 116 of the DGGS 110 described with reference to FIGS. 2A and 2B.

In the same or different embodiments, operation 410 may include an operation 503 for generating a uniform resource identifier. The logic of operation 503 may be performed, for example, by the uniform resource identifier generation module 294 of the persistent state generation module 116 of the DGGS 110 described with reference to FIGS. 2A and 2B by generating a uniform resource identifier (URI, or uniform resource locator, URL) that represents the indicated area (e.g., area 25).

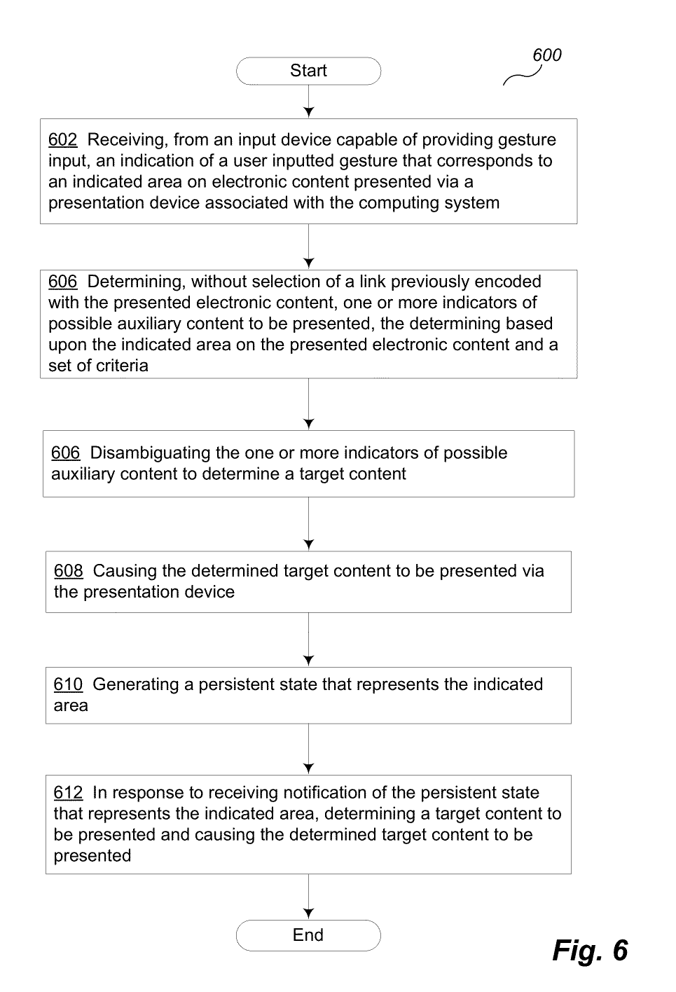

FIG. 6 is an example flow diagram of example logic illustrating another embodiment for automatically providing navigation to target content. The logic of FIG. 6 includes, as a portion, the logic included in FIG. 4. In particular, the logic described by operations 602, 604, 606, 608, and 610 follows that of corresponding operations in FIG. 4. In addition, operational flow 600 includes operation 612 which performs, in response to receiving notification of the persistent state that represents the indicated area, determining a target content to be presented and causing the determined target content to be presented. This logic may be performed, for example, by the gesturelet detection and resolution module 229 of input module 111 of the DGGS 110 described with reference to FIGS. 2A and 2B by determining a target content that is associated with the gesturelet, using for example, the target content determination module 114, and causing the determined target content to be presented, using for example, the automated navigation module 113 and the presentation module 112 of the DGGS 110 described with reference to FIGS. 2A and 2F.

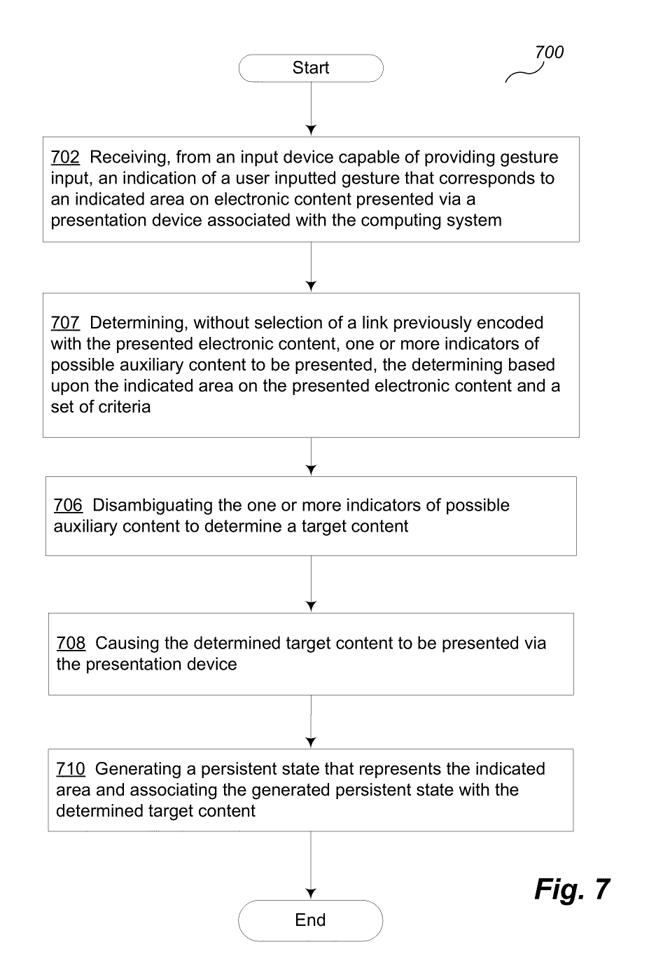

FIG. 7 is an example flow diagram of example logic illustrating another embodiment for automatically providing navigation to target content. The logic of FIG. 7 includes, as a portion, the logic included in FIG. 3. In particular, the logic described by operations 702, 704, 706, and 708 follows that of corresponding operations in FIG. 3. In addition, operational flow 700 includes operation 710 which performs generating a persistent state that represents the indicated area and associating the generated persistent state with the determined target content. This logic may be performed, for example, by the persistent state generation module 116 of the DGGS 110 described with reference to FIG. 2A by generating a representation of the indicated area (e.g., area 25) in memory (e.g., memory 101 in FIG. 24) and associating (e.g., correlating, linking, joining, making reference to, storing, relating, uniting, combining, and the like) the representation with the determined target content.

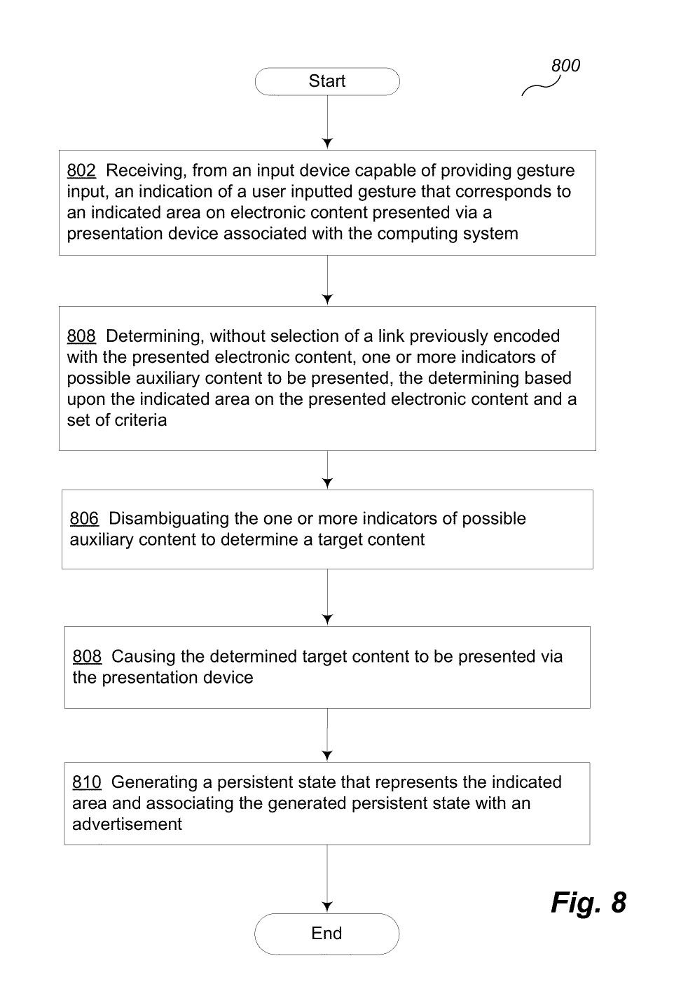

FIG. 8 is an example flow diagram of example logic illustrating another embodiment for automatically providing navigation to target content. The logic of FIG. 8 includes, as a portion, the logic included in FIG. 3. In particular, the logic described by operations 802, 804, 806, and 808 follows that of corresponding operations in FIG. 3. In addition, operational flow 800 includes operation 810 which performs generating a persistent state that represents the indicated area and associating the generated persistent state with an advertisement This logic may be performed, for example, by the advertisement determination module 242 provided by the auxiliary content determination module 122, provided by the target content determination module 114 of DGGS 110 as described with reference to FIGS. 2A and 2E by generating a representation of the indicated area (e.g., area 25) in memory (e.g., memory 101 in FIG. 24) and associating the representation with an advertisement, such as advertisement example 008 in FIG. 1A.

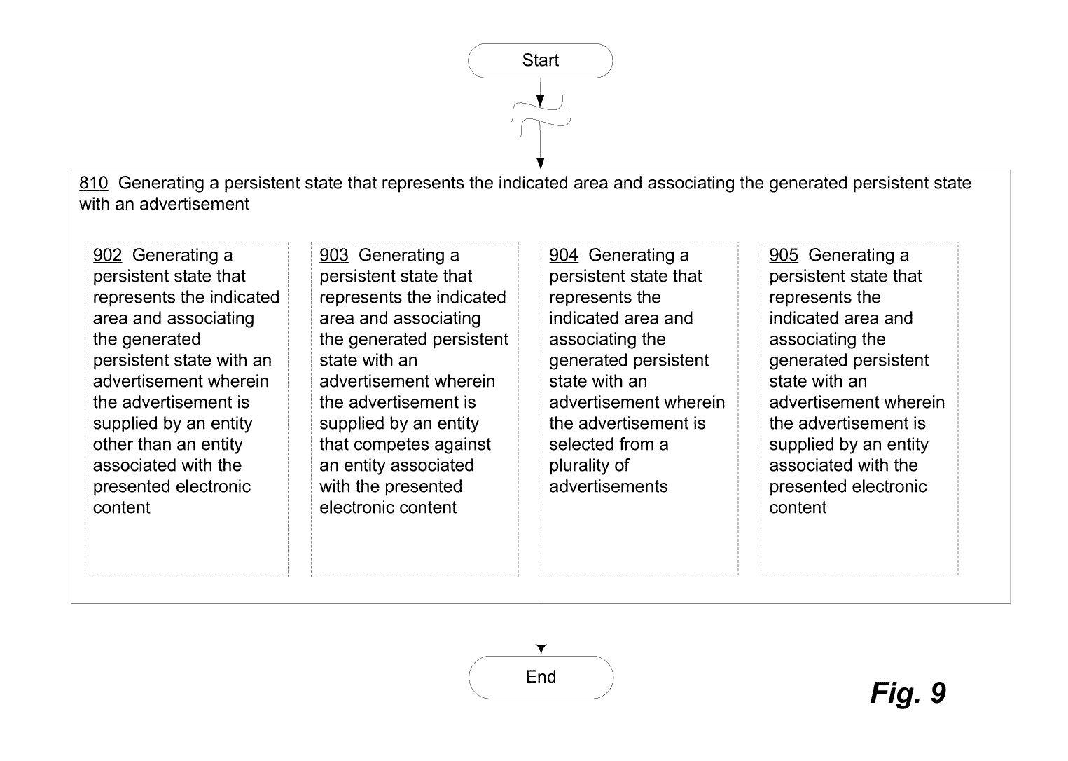

FIG. 9 is an example flow diagram of example logic illustrating various example embodiments of block 810 of FIG. 8. In some embodiments, the logic of operation 810 for generating a persistent state that represents the indicated area and associating the generated persistent state with an advertisement may include operation 902 whose logic specifies that the advertisement is supplied by an entity other than an entity associated with the presented electronic content. The logic of operation 902 may be performed, for example, by the advertisement determination module 242 of the DGGS 110 as described with reference to FIGS. 2A and 2E by obtaining an advertisement from, for example, one of the providers remote to the computing system 100 (e.g., one of providers 42-46 described with reference to FIG. 1B).

In the same or different embodiments, operation 810 may include an operation 903 whose logic specifies that the advertisement is supplied by an entity that competes against an entity associated with the presented electronic content. The logic of operation 903 may be performed, for example, by the advertisement determination module 242 of the DGGS 110 as described with reference to FIGS. 2A and 2E. One of the providers remote to the computing system 100 (e.g., one of providers 42-46 described with reference to FIG. 1B) may be one that competes against an entity associated with the presented electronic content.

In the same or different embodiments, operation 810 may include an operation 904 whose logic specifies that the advertisement is selected from a plurality of advertisements. The logic of operation 504 may be performed, for example, by the advertisement determination module 242 of the DGGS 110 as described with reference to FIGS. 2A and 2E. As described with reference to FIG. 2E, third party auxiliary content provider 43 may be configured, for example, as a third party ad provider that provides one or more advertisements that match an input query, for example, a set of keywords.

In the same or different embodiments, operation 810 may include an operation 905 whose logic specifies that the advertisement is supplied by an entity associated with the presented electronic content. The logic of operation 504 may be performed, for example, by the advertisement determination module 242 of the DGGS 110 as described with reference to FIGS. 2A and 2E. For example, the advertisement may come from auxiliary content 40 or from cloud storage 44 (see FIG. 1B)

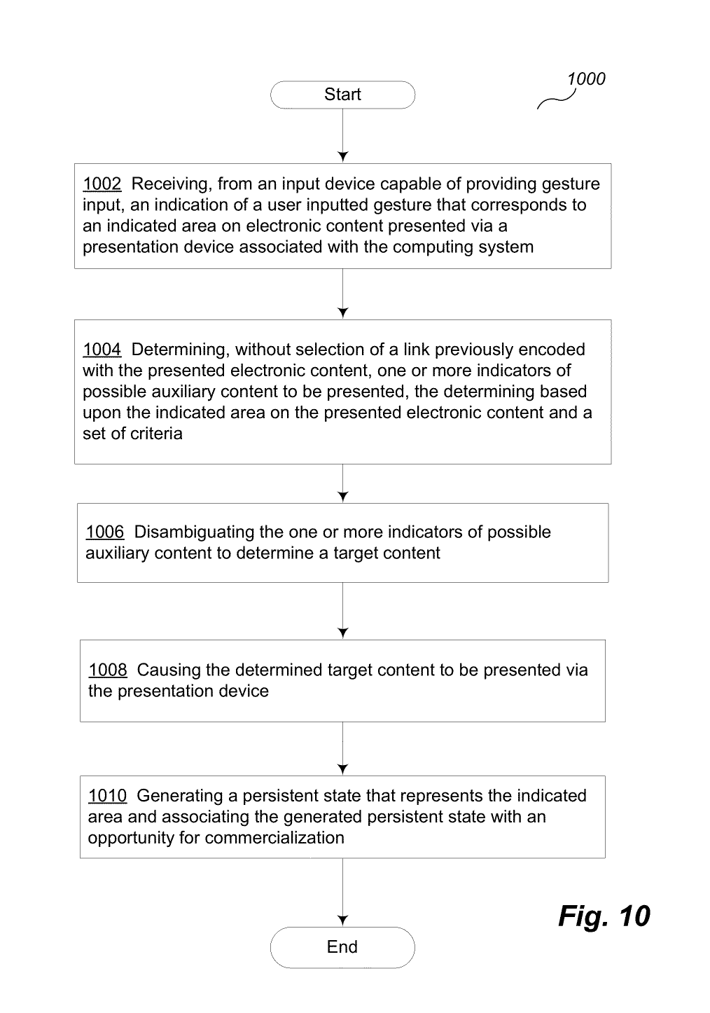

FIG. 10 is an example flow diagram of example logic illustrating another embodiment for automatically providing navigation to target content. The logic of FIG. 10 includes, as a portion, the logic included in FIG. 3. In particular, the logic described by operations 1002, 1004, 1006, and 1008 follows that of corresponding operations in FIG. 3. In addition, operational flow 1000 includes operation 1010 which performs generating a persistent state that represents the indicated area and associating the generated persistent state with an opportunity for commercialization. This logic may be performed, for example, by the association with opportunity for commercialization module 208 provided by the association with auxiliary or supplemental content module 206 of the persistent state generation module 116 of the DGGS 110 described with reference to FIGS. 2A and 2B by generating a representation of the indicated area (e.g., area 25) in memory (e.g., memory 101 in FIG. 24) and associating the representation with something that can be commercialized, such as an advertisement, an offer, a bid, a certificate, products, services, or the like.

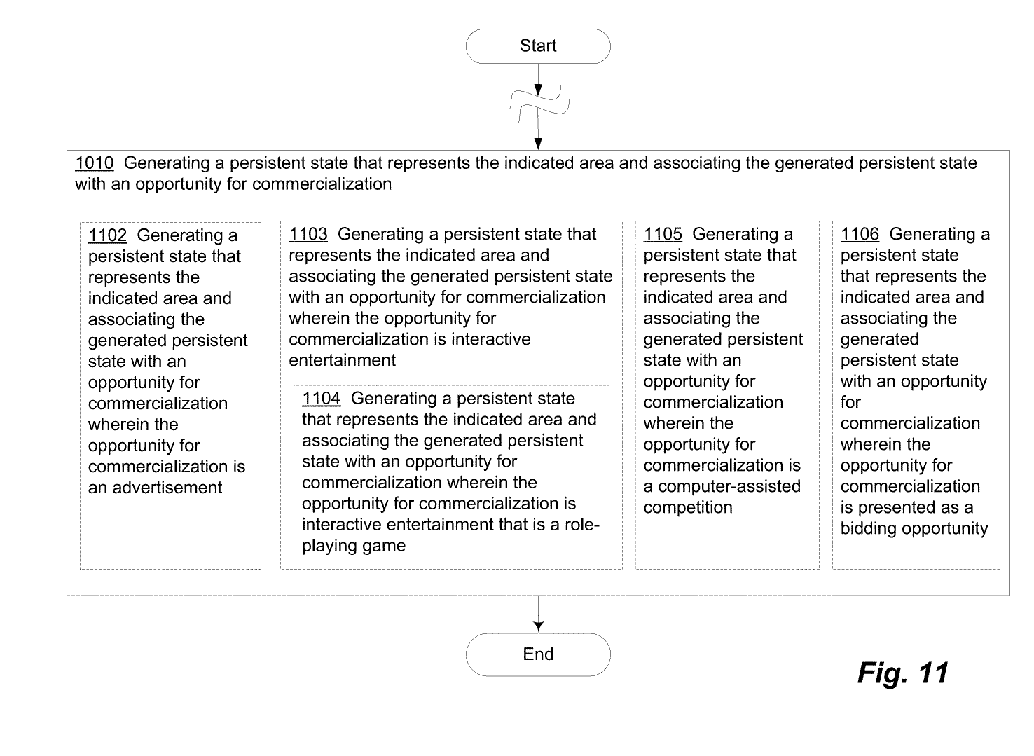

FIG. 11 is an example flow diagram of example logic illustrating various example embodiments of block 1010 of FIG. 10. In some embodiments, the logic of operation 1010 for generating a persistent state that represents the indicated area and associating the generated persistent state with an opportunity for commercialization may include operation 1102 whose logic specifies that the opportunity for commercialization is an advertisement. The logic of operation 1102 may be performed, for example, by the association with opportunity for commercialization module 208 and/or by the association with advertisement module 207 provided by the association with auxiliary or supplemental content module 206 of the persistent state generation module 116 of the DGGS 110 described with reference to FIGS. 2A and 2B by generating a representation of the indicated area (e.g., area 25) in memory (e.g., memory 101 in FIG. 24) and associating the representation with an advertisement.

In the same or different embodiments, operation 1010 may include an operation 1103 whose logic specifies that the opportunity for commercialization is interactive entertainment. The logic of operation 1103 may be performed, for example, by the association with interactive entertainment module 201 provided by the association with opportunity for commercialization module 208 provided by the association with auxiliary or supplemental content module 206 of the persistent state generation module 116 of the DGGS 110 described with reference to FIGS. 2A and 2B by generating a representation of the indicated area (e.g., area 25) in memory (e.g., memory 101 in FIG. 24) and associating the representation with some sort of interactive entertainment (e.g., a computer game, an on-line quiz show, a lottery, a movie to watch, and so forth).

In some embodiments, operation 1103 may further include an operation 1104 whose logic specifies that the interactive entertainment is a role-playing game. The logic of operation 1104 may be performed, for example, by the association with role playing game module provided by the association with interactive entertainment module 201 provided by the association with opportunity for commercialization module 208 provided by the association with auxiliary or supplemental content module 206 of the persistent state generation module 116 of the DGGS 110 described with reference to FIGS. 2A and 2B by generating a representation of the indicated area (e.g., area 25) in memory (e.g., memory 101 in FIG. 24) and associating the representation with a role-playing game. The role playing game may be a multi-player online role playing game (MMRPG) or a standalone, single or multi-player role playing game, or some other form of online, manual, or other role playing game.

In the same or different embodiments, operation 1010 may include an operation 1105 whose logic specifies that the opportunity for commercialization is a computer-assisted competition. The logic of operation 1105 may be performed, for example, by the association with role playing game module provided by the association with computer assisted competition module 203 provided by the association with opportunity for commercialization module 208 provided by the association with auxiliary or supplemental content module 206 of the persistent state generation module 116 of the DGGS 110 described with reference to FIGS. 2A and 2B by generating a representation of the indicated area (e.g., area 25) in memory (e.g., memory 101 in FIG. 24) and associating the representation with some type of computer-assisted competition. The competition could be outside of the computing system as long as it is somehow assisted by a computer.

In the same or different embodiments, operation 1010 may include an operation 1106 whose logic specifies that the opportunity for commercialization is a presented as a bidding opportunity. The logic of operation 1105 may be performed, for example, by the association with role playing game module provided by the association with bidding module 205 provided by the association with opportunity for commercialization module 208 provided by the association with auxiliary or supplemental content module 206 of the persistent state generation module 116 of the DGGS 110 described with reference to FIGS. 2A and 2B by generating a representation of the indicated area (e.g., area 25) in memory (e.g., memory 101 in FIG. 24) and associating the representation with some type of bidding opportunity, computer based, computer-assisted, and/or manual.

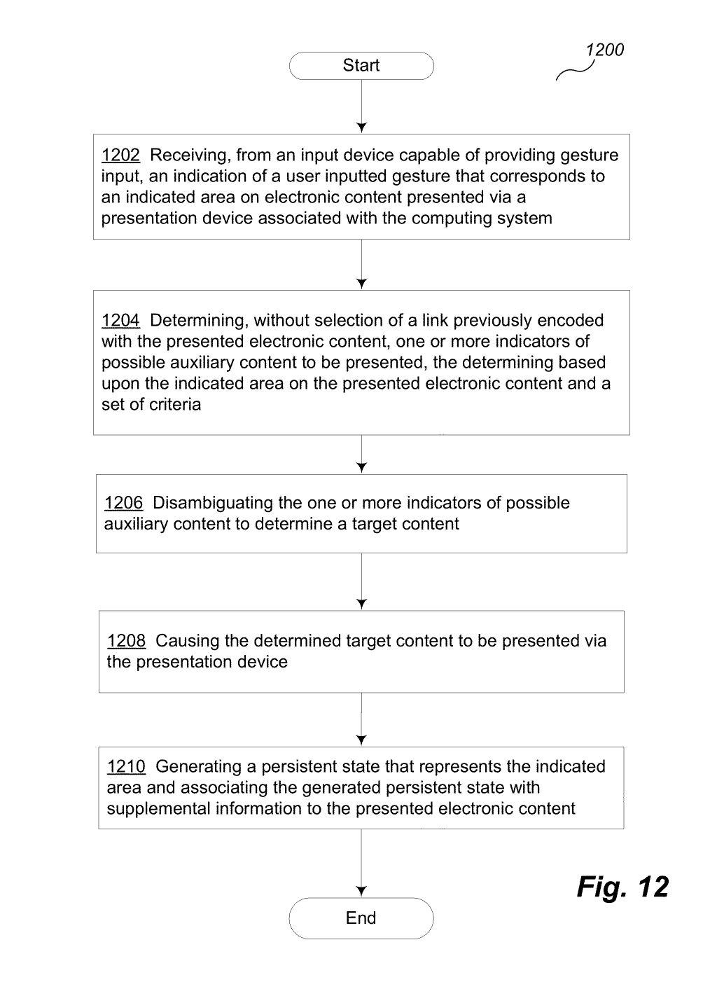

FIG. 12 is an example flow diagram of example logic illustrating another embodiment for automatically providing navigation to target content. The logic of FIG. 12 includes, as a portion, the logic included in FIG. 3. In particular, the logic described by operations 1202, 1204, 1206, and 1208 follows that of corresponding operations in FIG. 3. In addition, operational flow 1200 includes operation 1210 which performs generating a persistent state that represents the indicated area and associating the generated persistent state with supplemental information to the presented electronic content. This logic may be performed, for example, by the association with auxiliary or supplemental content module 206 of the persistent state generation module 116 of the DGGS 110 described with reference to FIGS. 2A and 2B by generating a representation of the indicated area (e.g., area 25) in memory (e.g., memory 101 in FIG. 24) and associating the representation with supplemental information of some nature (e.g., an additional document or portion thereof, map, web page, advertisement, and so forth).

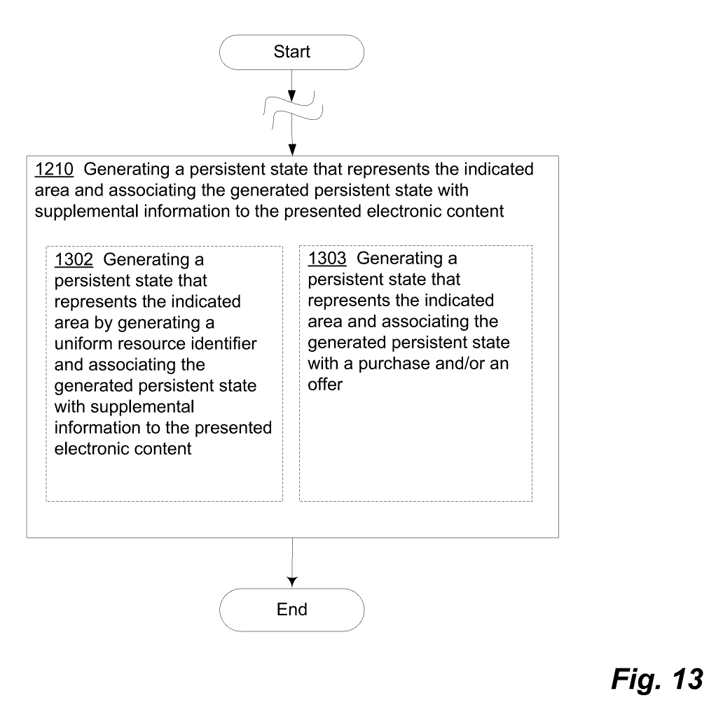

FIG. 13 is an example flow diagram of example logic illustrating various example embodiments of block 1210 of FIG. 12. In some embodiments, the logic of operation 1210 for generating a persistent state that represents the indicated area and associating the generated persistent state with supplemental information to the presented electronic content may include operation 1302 whose logic specifies that generating a persistent state comprises generating a uniform resource identifier. The logic of operation 1102 may be performed, for example, by the uniform resource identifier generation module 204 of the persistent state generation module 116 of the DGGS 110 described with reference to FIGS. 2A and 2B by generating a representation of the indicated area (e.g., area 25) as a URL. In some embodiments the URL may directly encode the persistent state (an indication of the portion of content indicated and its association to target content). In other embodiments, the URL may refer to memory (e.g., memory 101 in FIG. 24) that stores the information. Combinations are also possible.

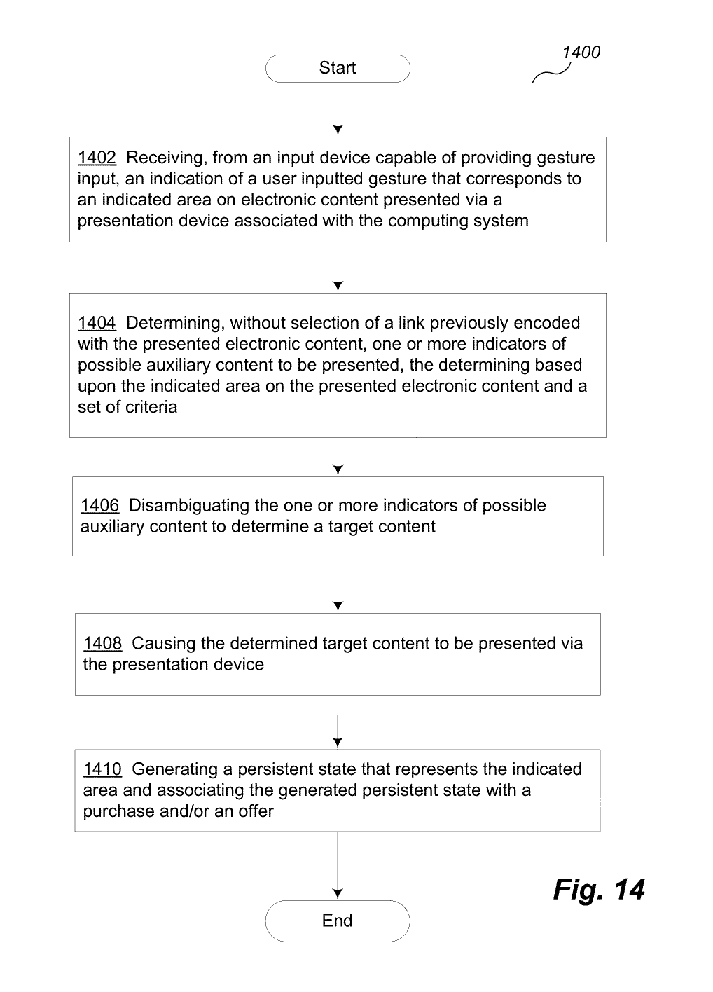

FIG. 14 is an example flow diagram of example logic illustrating another embodiment for automatically providing navigation to target content. The logic of FIG. 14 includes, as a portion, the logic included in FIG. 3. In particular, the logic described by operations 1402, 1404, 1406, and 1408 follows that of corresponding operations in FIG. 3. In addition, operational flow 1400 includes operation 1410 which performs generating a persistent state that represents the indicated area and associating the generated persistent state with a purchase and/or an offer. This logic may be performed, for example, by the association with purchase and/or offer module 209 provided by the association with opportunity for commercialization module 208 provided by the association with auxiliary or supplemental content module 206 of the persistent state generation module 116 of the DGGS 110 described with reference to FIGS. 2A and 2B by generating a representation of the indicated area (e.g., area 25) in memory (e.g., memory 101 in FIG. 24) and associating the representation with some sort of purchase and/or offer for purchase.

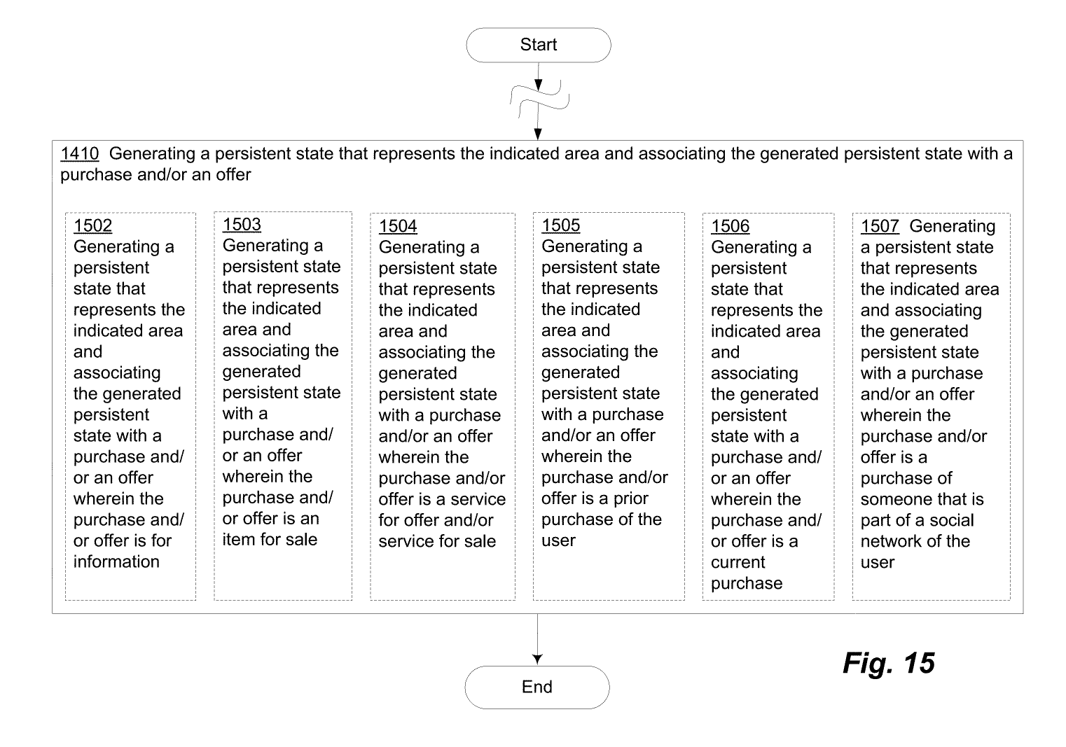

FIG. 15 is an example flow diagram of example logic illustrating various example embodiments of block 1410 of FIG. 14. In some embodiments, the logic of operation 1410 for generating a persistent state that represents the indicated area and associating the generated persistent state with a purchase and/or an offer may include operation 1502 whose logic specifies that the purchase and/or offer is for information. The logic of operation 1502 may be performed, for example, by the association with purchase and/or offer module 209 provided by the association with opportunity for commercialization module 208 provided by the association with auxiliary or supplemental content module 206 of the persistent state generation module 116 of the DGGS 110 described with reference to FIGS. 2A and 2B by generating a representation of the indicated area (e.g., area 25) in memory (e.g., memory 101 in FIG. 24) and associating the representation with a purchase and/or offer for purchase of information. Any type of information can be offered and/or purchased in this manner.

In the same or different embodiments, operation 1410 may include an operation 1503 whose logic specifies that the purchase and/or offer is an item for sale. The logic of operation 1503 may be performed, for example, by the association with purchase and/or offer module 209 provided by the association with opportunity for commercialization module 208 provided by the association with auxiliary or supplemental content module 206 of the persistent state generation module 116 of the DGGS 110 described with reference to FIGS. 2A and 2B by generating a representation of the indicated area (e.g., area 25) in memory (e.g., memory 101 in FIG. 24) and associating the representation with a purchase and/or offer for sale of an item. Any item, online or not, may be purchased.

In the same or different embodiments, operation 1410 may include an operation 1504 whose logic specifies that the purchase and/or offer is a service for offer and/or service for sale. The logic of operation 1504 may be performed, for example, by the association with purchase and/or offer module 209 provided by the association with opportunity for commercialization module 208 provided by the association with auxiliary or supplemental content module 206 of the persistent state generation module 116 of the DGGS 110 described with reference to FIGS. 2A and 2B by generating a representation of the indicated area (e.g., area 25) in memory (e.g., memory 101 in FIG. 24) and associating the representation with a purchase or sale of any type of service, machine generated or human generated. If human generated the association is to a computer representation of the human generated service, for example, a contract or a calendar reminder.

In the same or different embodiments, operation 1410 may include an operation 1505 whose logic specifies that the purchase and/or offer is a prior purchase of the user. The logic of operation 1505 may be performed, for example, by the association with purchase and/or offer module 209 provided by the association with opportunity for commercialization module 208 provided by the association with auxiliary or supplemental content module 206 of the persistent state generation module 116 of the DGGS 110 described with reference to FIGS. 2A and 2B by generating a representation of the indicated area (e.g., area 25) in memory (e.g., memory 101 in FIG. 24) and associating the representation with a prior purchase of the user. Prior purchase information may be stored local to the DGGS 110, or may be available over the one or more networks 30.

In the same or different embodiments, operation 1410 may include an operation 1506 whose logic specifies that the purchase and/or offer is a current purchase. The logic of operation 1506 may be performed, for example, by the association with purchase and/or offer module 209 provided by the association with opportunity for commercialization module 208 provided by the association with auxiliary or supplemental content module 206 of the persistent state generation module 116 of the DGGS 110 described with reference to FIGS. 2A and 2B by generating a representation of the indicated area (e.g., area 25) in memory (e.g., memory 101 in FIG. 24) and associating the representation with a purchase currently underway, possibly as part of the presented content.

In the same or different embodiments, operation 1410 may include an operation 1507 whose logic specifies that the purchase and/or offer is a purchase of an entity that is part of a social network of the user. The logic of operation 1507 may be performed, for example, by the association with purchase and/or offer module 209 provided by the association with opportunity for commercialization module 208 provided by the association with auxiliary or supplemental content module 206 of the persistent state generation module 116 of the DGGS 110 described with reference to FIGS. 2A and 2B by generating a representation of the indicated area (e.g., area 25) in memory (e.g., memory 101 in FIG. 24) and associating the representation with a purchase of someone that belongs to a social network associated with the user, for example through the one or more networks 30.

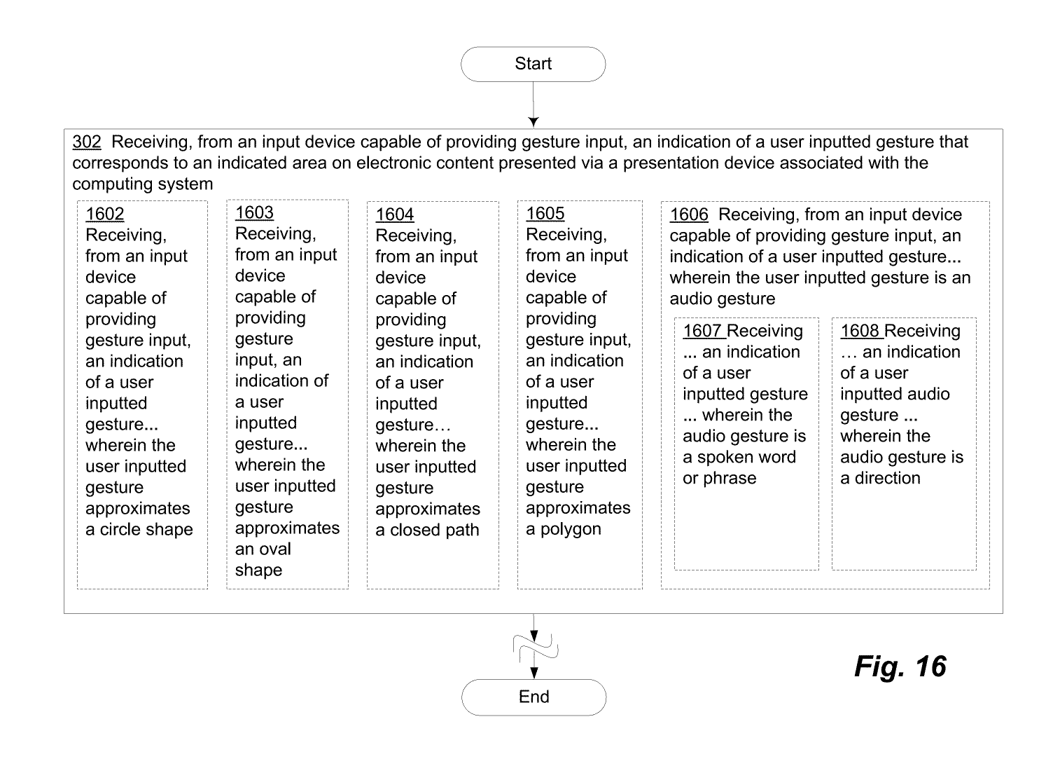

FIG. 16 is an example flow diagram of example logic illustrating various example embodiments of block 302 of FIG. 3. In some embodiments, the logic of operation 302 for receiving, from an input device capable of providing gesture input, an indication of a user inputted gesture that corresponds to an indicated area on electronic content presented via a presentation device associated with the computing system may include operation 1602 whose logic specifies that the user inputted gesture approximates a circle shape. The logic of operation 1602 may be performed, for example, by the graphics handling module 224 provided by the gesture input detection and resolution module 121 provided by the input module 111 of the DGGS 110 described with reference to FIGS. 2A and 2C to detect whether a received gesture is in a form that approximates a circle shape.

In the same or different embodiments, operation 302 may include an operation 1603 whose logic specifies that the user inputted gesture approximates an oval shape. The logic of operation 1603 may be performed, for example, by the graphics handling module 224 provided by the gesture input detection and resolution module 121 provided by the input module 111 of the DGGS 110 described with reference to FIGS. 2A and 2C to detect whether a received gesture is in a form that approximates an oval shape.

In the same or different embodiments, operation 302 may include an operation 1604 whose logic specifies that the user inputted gesture approximates a closed path. The logic of operation 1604 may be performed, for example, by the graphics handling module 224 provided by the gesture input detection and resolution module 121 provided by the input module 111 of the DGGS 110 described with reference to FIGS. 2A and 2C to detect whether a received gesture is in a form that approximates a closed path of points and/or line segments.

In the same or different embodiments, operation 302 may include an operation 1605 whose logic specifies that the user inputted gesture approximates a polygon. The logic of operation 1605 may be performed, for example, by the graphics handling module 224 provided by the gesture input detection and resolution module 121 provided by the input module 111 of the DGGS 110 described with reference to FIGS. 2A and 2C to detect whether a received gesture is in a form that approximates a polygon.

In the same or different embodiments, operation 302 may include an operation 1606 whose logic specifies that the user inputted gesture is an audio gesture. The logic of operation 1606 may be performed, for example, by the audio handling module 222 provided by the gesture input detection and resolution module 121 provided by the input module 111 of the DGGS 110 described with reference to FIGS. 2A and 2C to detect whether a received gesture is an audio gesture, such as received via audio device, microphone 20b.

In some embodiments, operation 1606 may further include an operation 1607 whose logic specifies that the audio gesture is a spoken word or phrase. The logic of operation 1607 may be performed, for example, by the audio handling module 222 provided by the gesture input detection and resolution module 121 provided by the input module 111 of the DGGS 110 described with reference to FIGS. 2A and 2C to detect whether a received audio gesture, such as received via audio device, microphone 20b, indicates (e.g., designates or otherwise selects) a word or phrase indicating some portion of the presented content.

In some embodiments, operation 1606 may further include an operation 1608 whose logic specifies that the audio gesture is a direction. The logic of operation 1608 may be performed, for example, by the audio handling module 222 provided by the gesture input detection and resolution module 121 provided by the input module 111 of the DGGS 110 described with reference to FIGS. 2A and 2C to detect a direction received from an audio input device, such as audio input device 20b. The direction may be a single letter, number, word, phrase, or any type of instruction or indication of where to move a cursor or locator device.

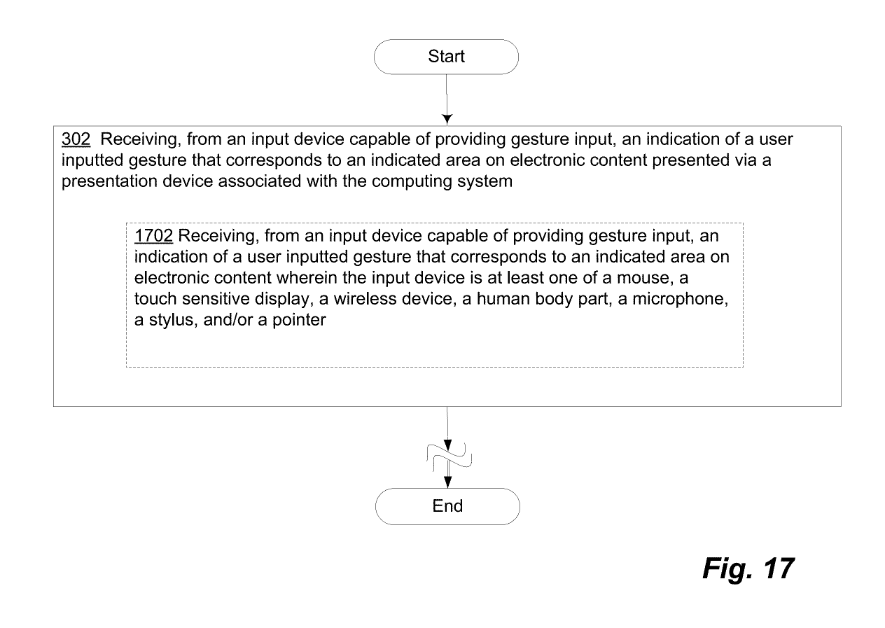

FIG. 17 is an example flow diagram of example logic illustrating various example embodiments of block 302 of FIG. 3. In some embodiments, the logic of operation 302 for receiving, from an input device capable of providing gesture input, an indication of a user inputted gesture that corresponds to an indicated area on electronic content presented via a presentation device associated with the computing system may include operation 1702 whose logic specifies that input device is at least one of a mouse, a touch sensitive display, a wireless device, a human body part, a microphone, a stylus, and/or a pointer. The logic of operation 1702 may be performed, for example, by the gesture input and resolution module 121 provided by the input module 111 of the DGGS 110 described with reference to FIGS. 2A and 2C to detect and resolve gesture input from, for example, devices 20*.

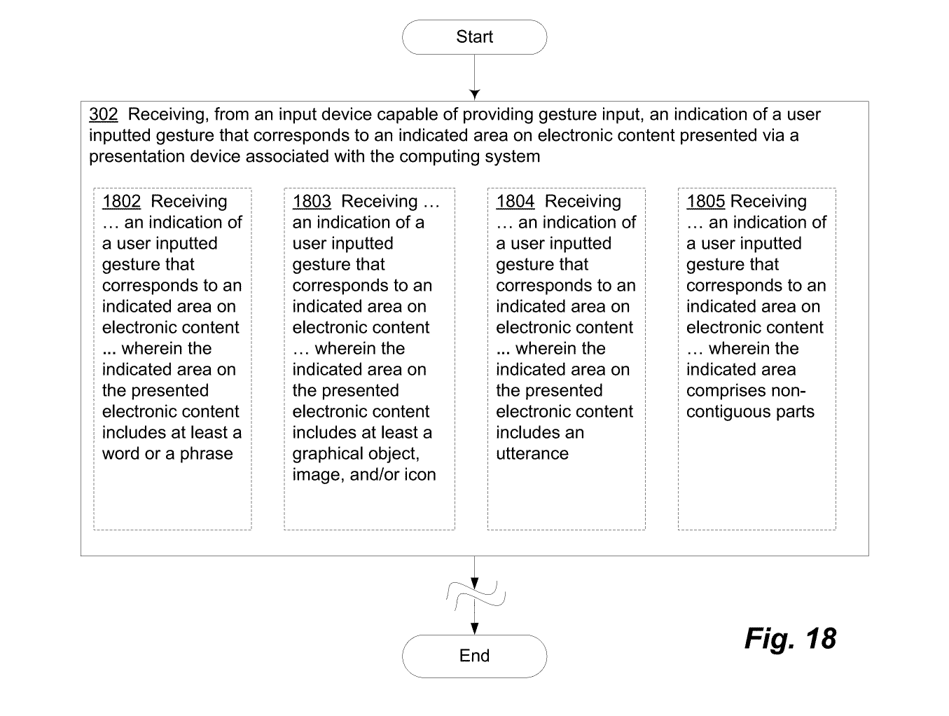

FIG. 18 is an example flow diagram of example logic illustrating various example embodiments of block 302 of FIG. 3. In some embodiments, the logic of operation 302 for receiving, from an input device capable of providing gesture input, an indication of a user inputted gesture that corresponds to an indicated area on electronic content presented via a presentation device associated with the computing system may include operation 1802 whose logic specifies that indicated area on the presented electronic content includes at least a word or a phrase. The logic of operation 1802 may be performed, for example, by the natural language processing module 226 provided by the gesture input and resolution module 121 provided by the input module 111 of the DGGS 110 described with reference to FIGS. 2A and 2C to detect and resolve gesture input from, for example, devices 20*. In this case, the module 226 is used to decipher word or phrase boundaries when, for example, the user 10* designates a circle, oval, polygon, closed path, etc. gesture that does not really map one to one with a set of words. Other attributes of the document and the user's prior navigation history may influence the ultimate word or phrase detected by the gesture input and resolution module 121.

In the same or different embodiments, operation 302 may include an operation 1803 whose logic specifies that the indicated area on the presented electronic content includes at least a graphical object, image, and/or icon. The logic of operation 1803 may be performed, for example, by the gesture input and resolution module 121 provided by the input module 111 of the DGGS 110 described with reference to FIGS. 2A and 2C to detect and resolve gesture input from, for example, devices 20*.

In the same or different embodiments, operation 302 may include an operation 1804 whose logic specifies that the indicated area on the presented electronic content includes an utterance. The logic of operation 1804 may be performed, for example, by the audio handling module 222 provided by the gesture input and resolution module 121 provided by the input module 111 of the DGGS 110 described with reference to FIGS. 2A and 2C to detect an utterance such as received from audio device microphone 20b.

In the same or different embodiments, operation 302 may include an operation 1805 whose logic specifies that the indicated area comprises non-contiguous parts. The logic of operation 1805 may be performed, for example, by the gesture input and resolution module 121 provided by the input module 111 of the DGGS 110 described with reference to FIGS. 2A and 2C to detect whether multiple portions of the presented content are indicated by the user as gestured-input. This may occur, for example, if the gesture is initiated using an audio device.

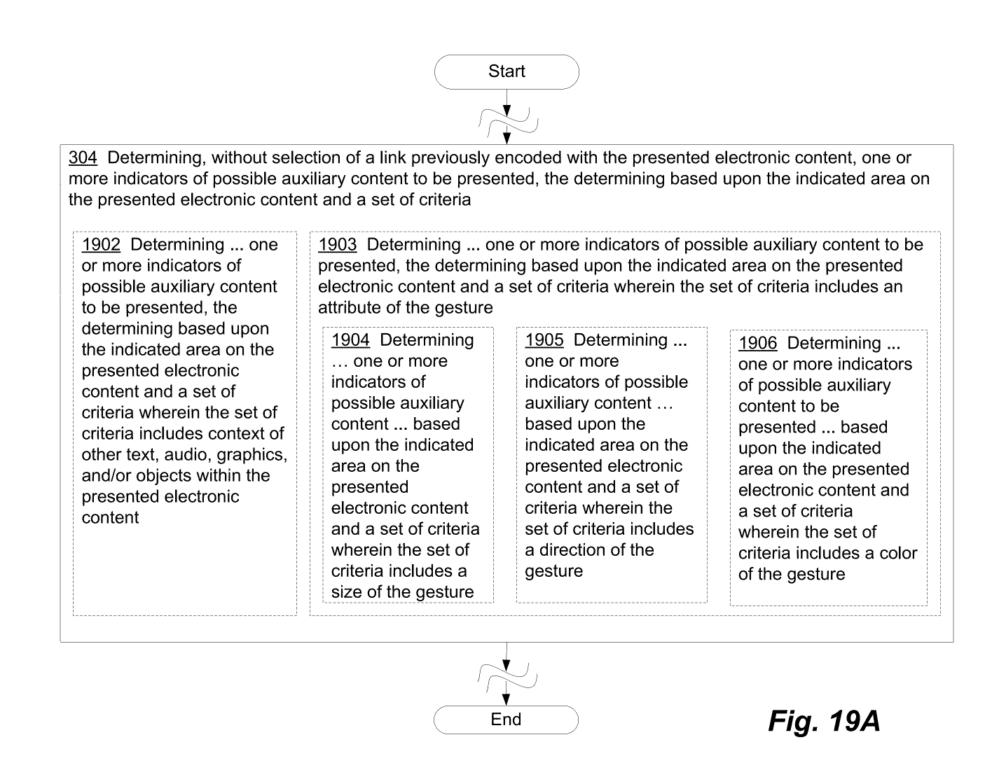

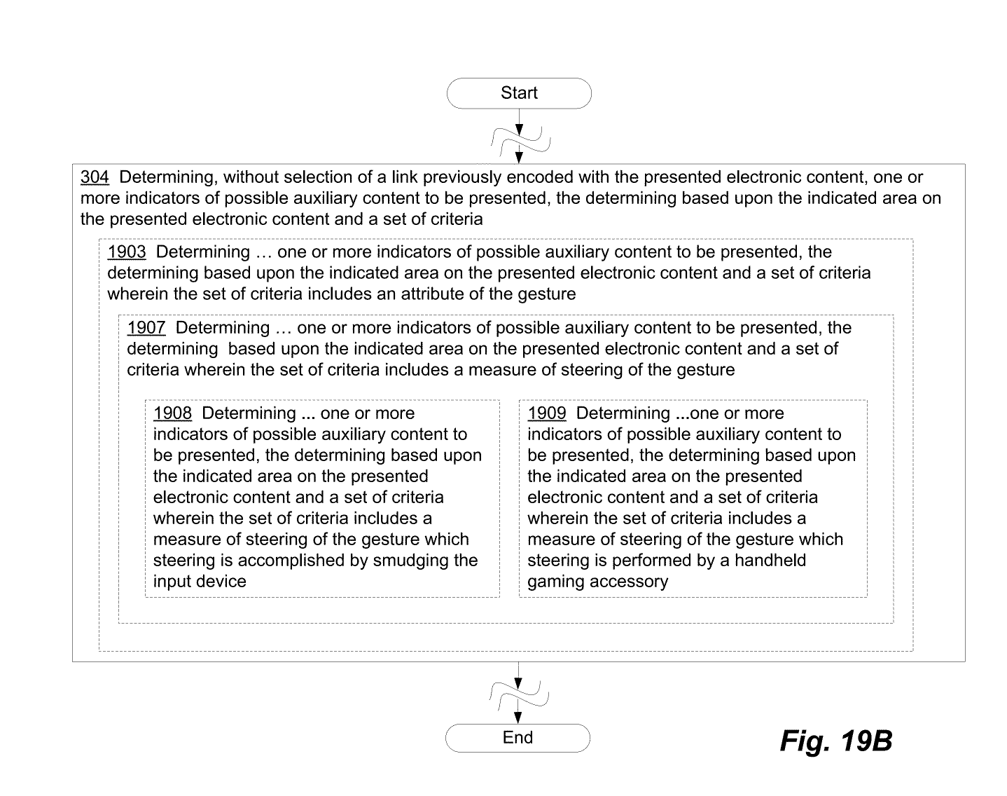

FIG. 19A is an example flow diagram of example logic illustrating various example embodiments of block 304 of FIG. 3. In some embodiments, the logic of operation 304 for determining, without selection of a link previously encoded with the presented electronic content, one or more indicators of possible auxiliary content to be presented, the determining based upon the indicated area on the presented electronic content and a set of criteria may include operation 1902 whose logic specifies that set of criteria includes context of other text, audio, graphics, and/or objects within the presented electronic content. The logic of operation 1902 may be performed, for example, by the current context determination module 231 provided by the criteria determination module 115 of the DGGS 110 described with reference to FIGS. 2A and 2D to determine (e.g., retrieve, designate, resolve, etc.) context related information from the currently presented content, including other text, audio, graphics, and/or objects.

In the same or different embodiments, operation 304 may include an operation 1903 whose logic specifies that set of criteria includes an attribute of the gesture. The logic of operation 1903 may be performed, for example, by the gesture attributes determination module 239 provided by the criteria determination module 115 of the DGGS 110 described with reference to FIGS. 2A and 2D to determine context related information from the attributes of the gesture itself (e.g., color, size, direction, shape, and so forth).

In the same or different embodiments, operation 304 may include an operation 1903 whose logic specifies that set of criteria includes an attribute of the gesture. The logic of operation 1903 may be performed, for example, by the gesture attributes determination module 239 provided by the criteria determination module 115 of the DGGS 110 described with reference to FIGS. 2A and 2D to determine context related information from the attributes of the gesture itself (e.g., color, size, direction, shape, and so forth).

In some embodiments, operation 1903 may further include an operation 1904 whose logic specifies that attribute of the gesture is the size of the gesture. The logic of operation 1904 may be performed, for example, by the gesture attributes determination module 239 provided by the criteria determination module 115 of the DGGS 110 described with reference to FIGS. 2A and 2D to determine context related information from the attributes of the gesture such as size. Size of the gesture may include, for example, width and/or length, and other measurements appropriate to the input device 20*.

In some embodiments, operation 1903 may further include an operation 1905 whose logic specifies that attribute of the gesture is a direction of the gesture. The logic of operation 1905 may be performed, for example, by the gesture attributes determination module 239 provided by the criteria determination module 115 of the DGGS 110 described with reference to FIGS. 2A and 2D to determine context related information from the attributes of the gesture such as direction. Direction of the gesture may include, for example, up or down, east or west, and other measurements appropriate to the input device 20*.

In some embodiments, operation 1903 may further include an operation 1906 whose logic specifies that attribute of the gesture is a color. The logic of operation 1906 may be performed, for example, by the gesture attributes determination module 239 provided by the criteria determination module 115 of the DGGS 110 described with reference to FIGS. 2A and 2D to determine context related information from the attributes of the gesture such as color. Color of the gesture may include, for example, a pen and/or ink color as well as other measurements appropriate to the input device 20*.

FIG. 19B is an example flow diagram of example logic illustrating various example embodiments of block 304 of FIG. 3. In some embodiments, the logic of operation 304 for determining, without selection of a link previously encoded with the presented electronic content, one or more indicators of possible auxiliary content to be presented, the determining based upon the indicated area on the presented electronic content and a set of criteria may include an operation 1903 whose logic specifies that set of criteria includes an attribute of the gesture. In some embodiments, the logic of operation 1903 may further include an operation 1907 whose logic specifies that attribute of the gesture is a measure of steering of the gesture. The logic of operation 1907 may be performed, for example, by the gesture attributes determination module 239 provided by the criteria determination module 115 of the DGGS 110 described with reference to FIGS. 2A and 2D to determine context related information from the attributes of the gesture such as steering. Steering of the gesture may occur when, for example, an initial gesture is indicated (e.g., on a mobile device) and the user desires to correct or nudge it in a certain direction.

In some embodiments, operation 1907 may further include an operation 1908 whose logic specifies that steering of the gesture is accomplished by smudging the input device. The logic of operation 1908 may be performed, for example, by the gesture attributes determination module 239 provided by the criteria determination module 115 of the DGGS 110 described with reference to FIGS. 2A and 2D to determine context related information from the attributes of the gesture such as smudging. Smudging of the gesture may occur when, for example, an initial gesture is indicated (e.g., on a mobile device) and the user desires to correct or nudge it in a certain direction by, for example “smudging” the gesture using for example, a finger. This type of action may be particularly useful on a touch screen input device.

In the same or different embodiments, operation 1907 may further include an operation 1909 whose logic specifies that steering of the gesture is performed by a handheld gaming accessory. The logic of operation 1909 may be performed, for example, by the gesture attributes determination module 239 provided by the criteria determination module 115 of the DGGS 110 described with reference to FIGS. 2A and 2D to determine context related information from the attributes of the gesture such as steering. In this case the steering is performed by a handheld gaming accessory such as a particular type of input device 20*.

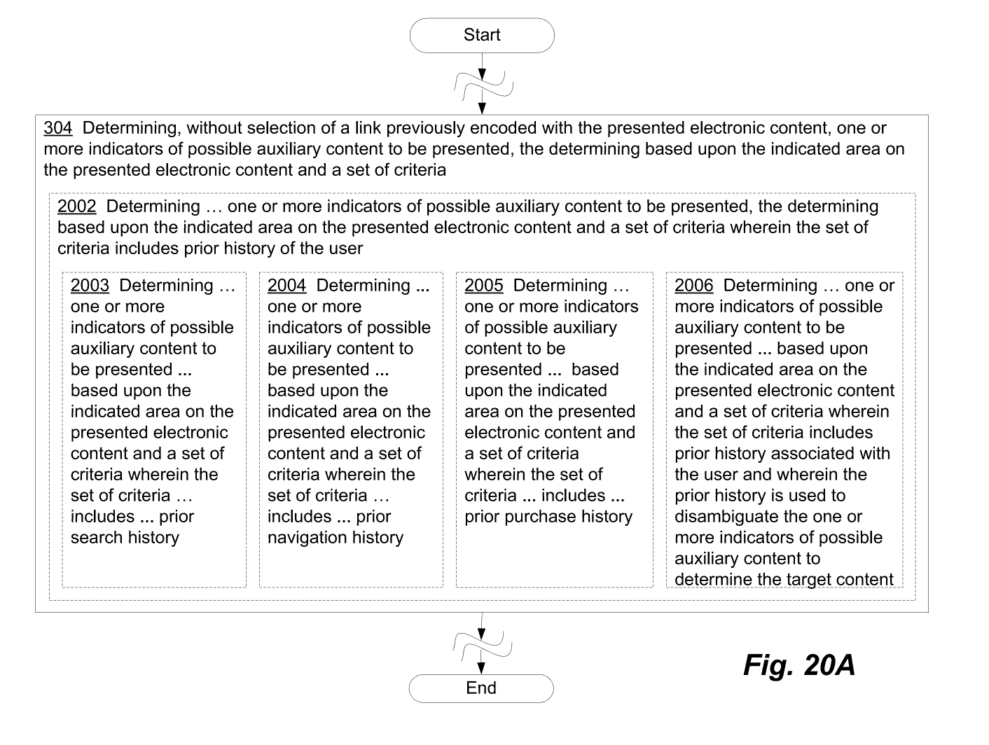

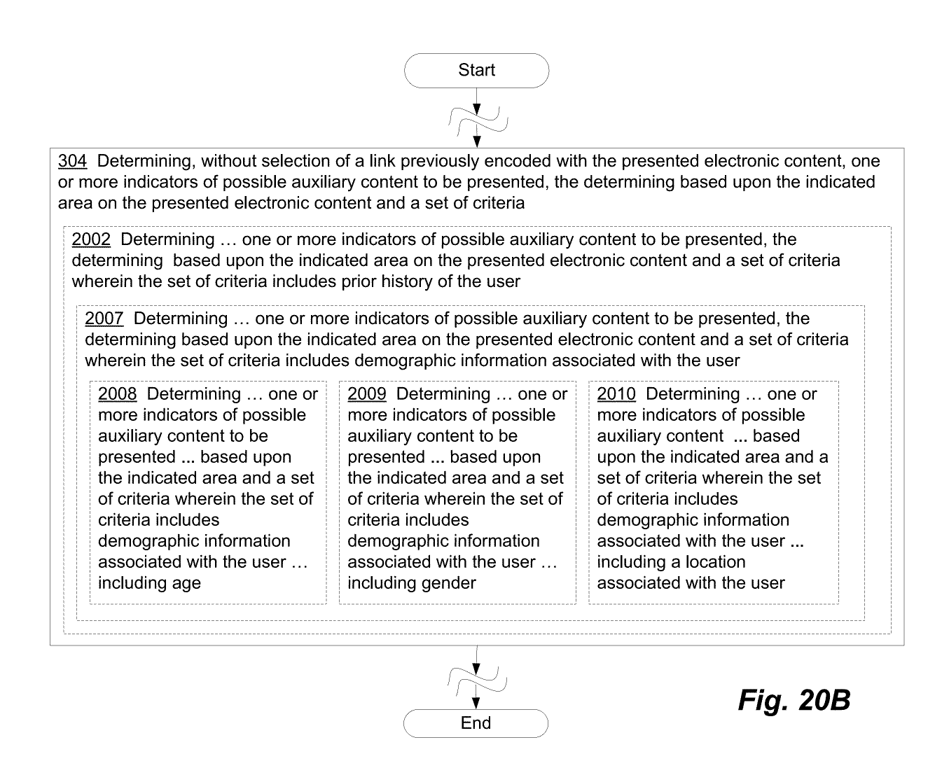

FIG. 20A is an example flow diagram of example logic illustrating various example embodiments of block 304 of FIG. 3. In some embodiments, the logic of operation 304 for determining, without selection of a link previously encoded with the presented electronic content, one or more indicators of possible auxiliary content to be presented, the determining based upon the indicated area on the presented electronic content and a set of criteria may include an operation 2002 whose logic specifies that set of criteria includes prior history associated with the user. The logic of operation 2002 may be performed, for example, by the prior history determination module 232 provided by the criteria determination module 115 of the DGGS 110 described with reference to FIGS. 2A and 2D to determine a set of criteria (e.g., factors, aspects, and the like) based upon some kind of prior history associated with the user.

In some embodiments, the logic of operation 2002 may further include an operation 2003 whose logic specifies that prior history associated with the user includes prior search history. The logic of operation 2003 may be performed, for example, by the search history determination module 235 provided by the prior history determination module 232 provided by the criteria determination module 115 of the DGGS 110 described with reference to FIGS. 2A and 2D to determine a set of criteria based upon the prior search history associated with the user. Factors such as what content the user has reviewed and searched for may be considered. Other factors may be considered as well.

In the same or different embodiments, the logic of operation 2002 may further include an operation 2004 whose logic specifies that prior history associated with the user includes prior navigation history. The logic of operation 2004 may be performed, for example, by the navigation history determination module 236 provided by the prior history determination module 232 provided by the criteria determination module 115 of the DGGS 110 described with reference to FIGS. 2A and 2D to determine a set of criteria based upon the prior navigation history associated with the user. Factors such as what content the user has reviewed, for how long, and where the user has navigated to from that point may be considered. Other factors may be considered as well.

In the same or different embodiments, the logic of operation 2002 may further include an operation 2005 whose logic specifies that prior history associated with the user includes prior purchase history. The logic of operation 2005 may be performed, for example, by the purchase history determination module 234 provided by the prior history determination module 232 provided by the criteria determination module 115 of the DGGS 110 described with reference to FIGS. 2A and 2D to determine a set of criteria based upon the prior purchase history associated with the user. Factors such as what products and/or services the user has bought may be considered. Other factors may be considered as well.

In the same or different embodiments, the logic of operation 2002 may further include an operation 2006 whose logic specifies that prior history associated with the user is used to disambiguate the one or more indicators of possible auxiliary content to determine the target content. The logic of operation 2006 may be performed, for example, by the prior history determination module 232 provided by the criteria determination module 115 of the DGGS 110 described with reference to FIGS. 2A and 2D. Prior history may provide insight to the DGGS 110, for example, to determine whether indicated content (hence indicated auxiliary content) points to certain persons, things, etc.

FIG. 20B is an example flow diagram of example logic illustrating various example embodiments of block 304 of FIG. 3. In some embodiments, the logic of operation 304 for determining, without selection of a link previously encoded with the presented electronic content, one or more indicators of possible auxiliary content to be presented, the determining based upon the indicated area on the presented electronic content and a set of criteria may include an operation 2002 whose logic specifies that the set of criteria includes prior history associated with the user. In the same or different embodiments, the logic of operation 2002 may further include an operation 2007 whose logic specifies that prior history associated with the user includes demographic information associated with the user. The logic of operation 2007 may be performed, for example, by the demographic history determination module 233 provided by the prior history determination module 232 provided by the criteria determination module 115 of the DGGS 110 described with reference to FIGS. 2A and 2D to determine a set of criteria based upon the demographic history associated with the user. Factors such as what the age, gender, location, citizenship, religious preferences (if specified) may be considered. Other factors may be considered as well.

In some embodiments, the logic of operation 2002 may further include an operation 2008 whose logic specifies that the set of criteria includes demographic information including age. The logic of operation 2008 may be performed, for example, by the demographic history determination module 233 provided by the prior history determination module 232 provided by the criteria determination module 115 of the DGGS 110 described with reference to FIGS. 2A and 2D to determine a set of criteria based upon the demographic history associated with the user including age.

In the same or different embodiments, the logic of operation 2002 may further include an operation 2009 whose logic specifies that the set of criteria includes demographic information including gender. The logic of operation 2009 may be performed, for example, by the demographic history determination module 233 provided by the prior history determination module 232 provided by the criteria determination module 115 of the DGGS 110 described with reference to FIGS. 2A and 2D to determine a set of criteria based upon the demographic history associated with the user including gender.

In the same or different embodiments, the logic of operation 2002 may further include an operation 2010 whose logic specifies that the set of criteria includes demographic information including a location associated with the user. The logic of operation 2010 may be performed, for example, by the demographic history determination module 233 provided by the prior history determination module 232 provided by the criteria determination module 115 of the DGGS 110 described with reference to FIGS. 2A and 2D to determine a set of criteria based upon the demographic history associated with the user including location. Location may include any location associated with the user included a residence, a work location, a home town, a birth location, and so forth.

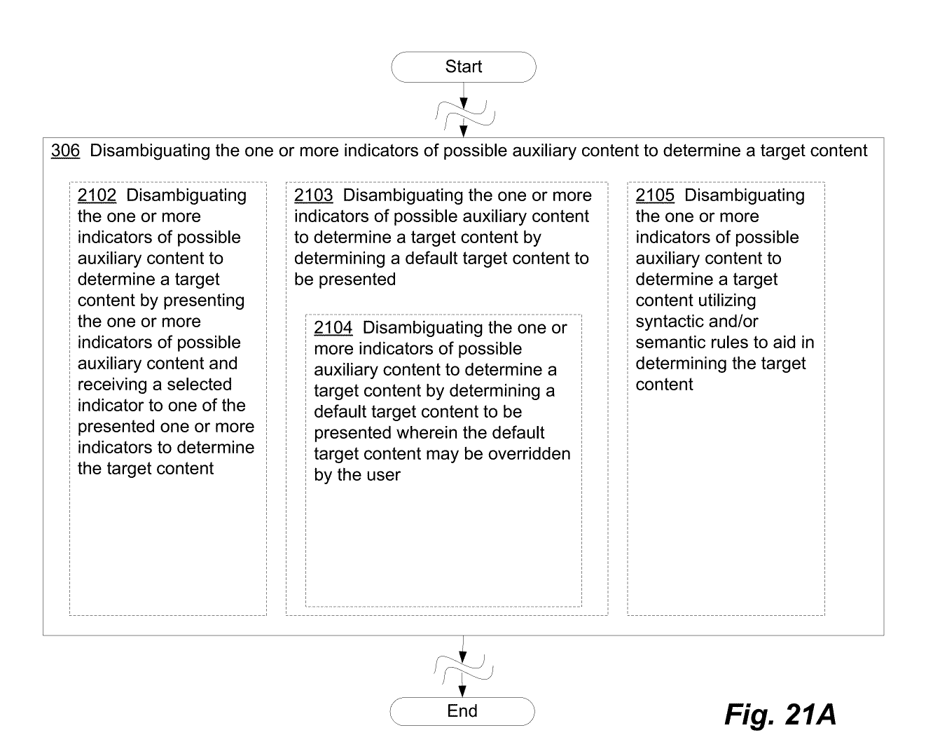

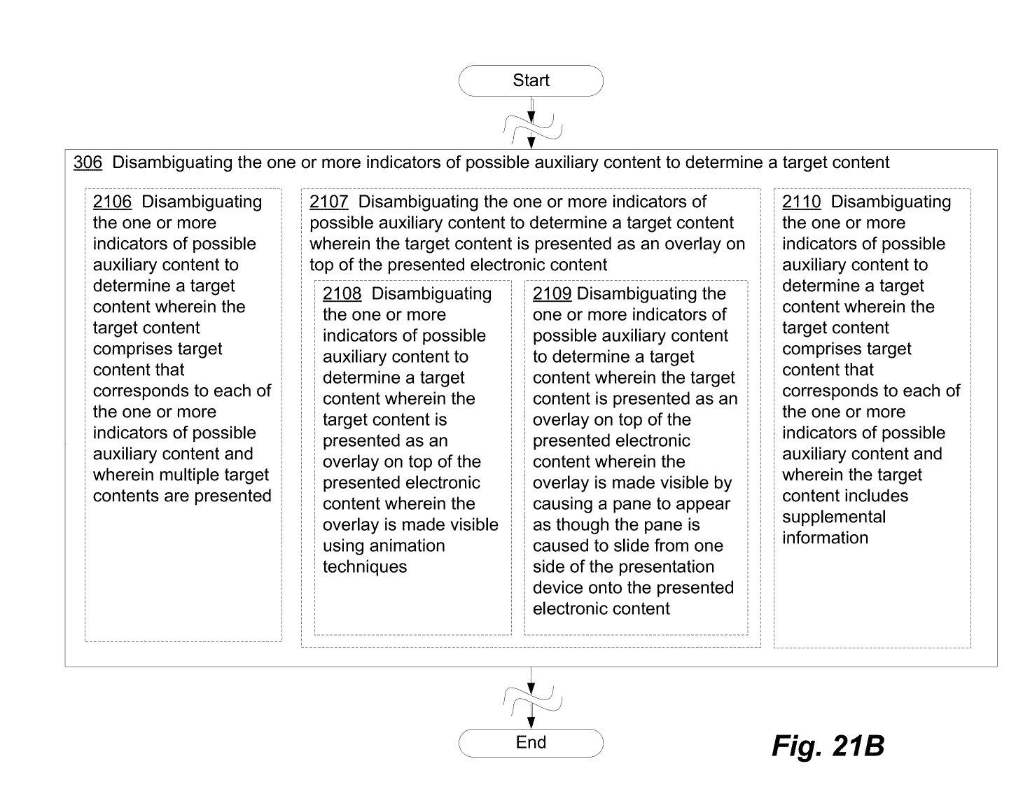

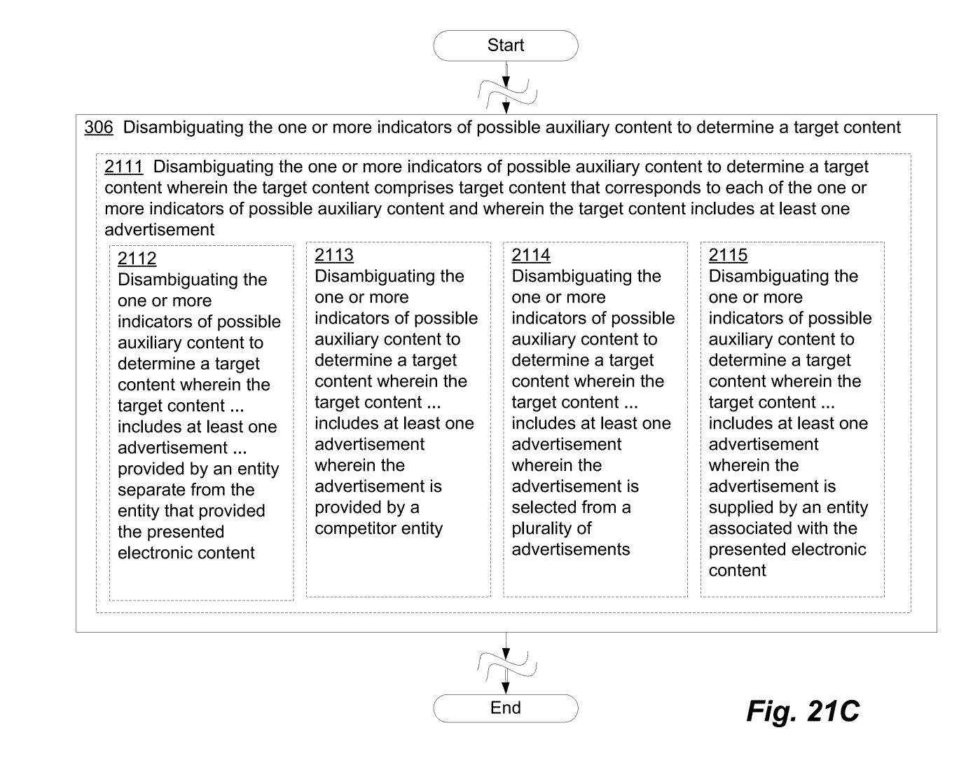

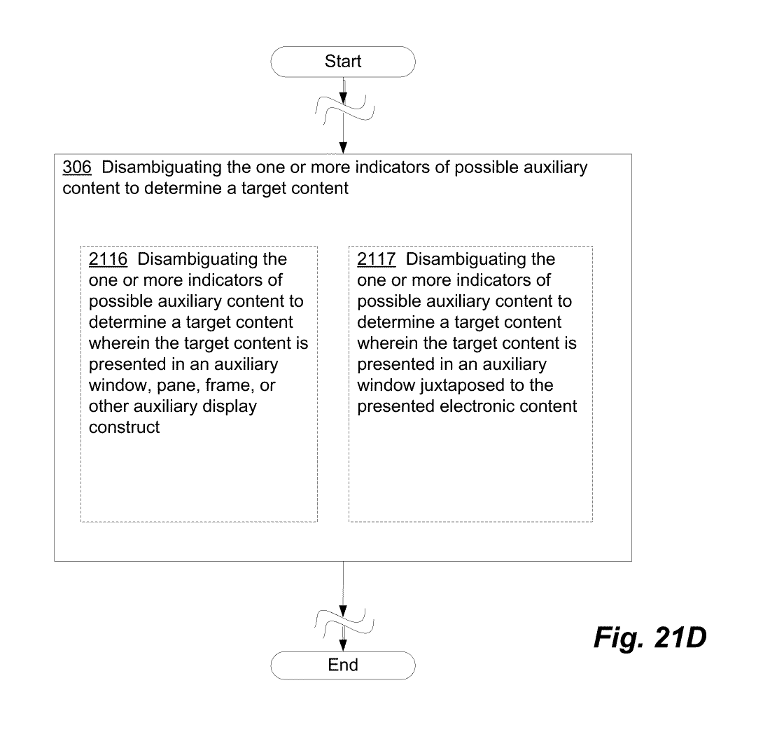

FIG. 21A is an example flow diagram of example logic illustrating various example embodiments of block 306 of FIG. 3. In some embodiments, the logic of operation 306 for disambiguating the one or more indicators of possible auxiliary content to determine a target content may include an operation 2102 whose logic specifies that disambiguating the one or more indicators of possible auxiliary content to determine the target content by presenting the one or more indicators of possible auxiliary content and receiving a selected indicator to one of the presented one or more indicators to determine the target content. The logic of operation 2102 may be performed, for example, by the disambiguation module 123 provided by the target content determination module 114 of the DGGS 110 described with reference to FIGS. 2A and 2E. Presenting the one or more indicators of possible auxiliary content allows a user 10* to select which auxiliary content to navigate to, especially in the case where there is some sort of ambiguity.

In the same or different embodiments, the logic of operation 306 may further include an operation 2103 whose logic specifies disambiguating the one or more indicators of possible auxiliary content by determining a default target content to be presented. The logic of operation 2103 may be performed, for example, by the default target content determination module provided by the disambiguation module 123 provided by the target content determination module 114 of the DGGS 110 described with reference to FIGS. 2A and 2E.

In some embodiments, the logic of operation 2103 may further include an operation 2104 whose logic specifies that default target content may be overridden by the user. The logic of operation 2104 may be performed, for example, by the default target content determination module 245 provided by the disambiguation module 123 provided by the target content determination module 114 of the DGGS 110 described with reference to FIGS. 2A and 2E. The DGGS 110 allows the user 10* to override an default auxiliary content presented in a variety of ways, including by specifying that no default content is to be presented.

In the same or different embodiments, the logic of operation 306 may further include an operation 2105 whose logic specifies disambiguating the one or more indicators of possible auxiliary content to determine a target content utilizing syntactic and/or semantic rules to aid in determining the target content. The logic of operation 2105 may be performed, for example, by the syntactic/semantic rules and/or natural language processing module 247 provided by the disambiguation module 123 provided by the target content determination module 114 of the DGGS 110 described with reference to FIGS. 2A and 2E. As described elsewhere, NLP-based mechanisms may be employed to determine what a user means by a gesture and hence what auxiliary content may be meaningful.

FIG. 21B is an example flow diagram of example logic illustrating various example embodiments of block 306 of FIG. 3. In the same or different embodiments, the logic of operation 306 for disambiguating the one or more indicators of possible auxiliary content to determine a target content may include an operation 2106 whose logic specifies that determined target content comprises target content that corresponds to each of the one or more indicators of possible auxiliary content and wherein multiple target contents are presented. The logic of operation 2106 may be performed, for example, by the disambiguation module 123 provided by the target content determination module 114 of the DGGS 110 described with reference to FIGS. 2A and 2E. Presenting multiple target auxiliary content allows a user 10* to select which auxiliary content to navigate to.

In the same or different embodiments, the logic of operation 306 for disambiguating the one or more indicators of possible auxiliary content to determine a target content may include an operation 2107 whose logic specifies that determined target content is presented as an overlay on top of the presented electronic content. The logic of operation 2107 may be performed, for example, by the disambiguation module 123 provided by the target content determination module 114 of the DGGS 110 described with reference to FIGS. 2A and 2E using aspects of the presentation module 112 described with reference to FIG. 2F, including the overlay presentation module 252.

In some embodiments, the logic of operation 2107 may further include an operation 2108 whose logic specifies that overlay is made visible using animation techniques determined target content is presented as an overlay on top of the presented electronic content. The logic of operation 2108 may be performed, for example, by the disambiguation module 123 provided by the target content determination module 114 of the DGGS 110 described with reference to FIGS. 2A and 2E using aspects of the presentation module 112 described with reference to FIG. 2F, including the overlay presentation module 252.

In the same or different embodiments, the logic of operation 2107 may further include an operation 2109 whose logic specifies that an overlay is made visible by causing a pane to appear as though the pane is caused to slide from one side of the presentation device onto the presented electronic content. The logic of operation 2109 may be performed, for example, by the disambiguation module 123 provided by the target content determination module 114 of the DGGS 110 described with reference to FIGS. 2A and 2E using aspects of the presentation module 112 described with reference to FIG. 2F, including the overlay presentation module 252.

In the same or different embodiments, the logic of operation 306 for disambiguating the one or more indicators of possible auxiliary content to determine a target content may include an operation 2110 whose logic specifies that determined target content includes supplemental information. The logic of operation 2110 may be performed, for example, by the supplemental content determination module 244 provided by the auxiliary content determination module 122 provided by the target content determination module 114 of the DGGS 110 described with reference to FIGS. 2A and 2E.

FIG. 21C is an example flow diagram of example logic illustrating various example embodiments of block 306 of FIG. 3. In the same or different embodiments, the logic of operation 306 for disambiguating the one or more indicators of possible auxiliary content to determine a target content may include an operation 2111 whose logic specifies that determined target content includes at least one advertisement. The logic of operation 2111 may be performed, for example, by the advertisement determination module 242 provided by the auxiliary content determination module 122 provided by the target content determination module 114 of the DGGS 110 described with reference to FIGS. 2A and 2E.

In some embodiments, the logic of operation 2111 may further include an operation 2112 whose logic specifies that the advertisement is provided by an entity separate from the entity that provided the presented electronic content. The logic of operation 2112 may be performed, for example, by the advertisement determination module 242 provided by the auxiliary content determination module 122 provided by the target content determination module 114 of the DGGS 110 described with reference to FIGS. 2A and 2E.

In the same or different embodiments the logic of operation 2111 may further include an operation 2113 whose logic specifies that the advertisement is provided by a competitor entity. The logic of operation 2113 may be performed, for example, by the advertisement determination module 242 provided by the auxiliary content determination module 122 provided by the target content determination module 114 of the DGGS 110 described with reference to FIGS. 2A and 2E.

In the same or different embodiments the logic of operation 2111 may further include an operation 2114 whose logic specifies that the advertisement is selected from a plurality of advertisements. The logic of operation 2114 may be performed, for example, by the advertisement determination module 242 provided by the auxiliary content determination module 122 provided by the target content determination module 114 of the DGGS 110 described with reference to FIGS. 2A and 2E.

In the same or different embodiments the logic of operation 2111 may further include an operation 2115 whose logic specifies that the advertisement is supplied by an entity associated with the presented electronic content. The logic of operation 2115 may be performed, for example, by the advertisement determination module 242 provided by the auxiliary content determination module 122 provided by the target content determination module 114 of the DGGS 110 described with reference to FIGS. 2A and 2E.

FIG. 21D is an example flow diagram of example logic illustrating various example embodiments of block 306 of FIG. 3. In the same or different embodiments, the logic of operation 306 for disambiguating the one or more indicators of possible auxiliary content to determine a target content may include an operation 2116 whose logic specifies that determined target content is presented in an auxiliary window, pane, frame, or other auxiliary display construct. The logic of operation 2116 may be performed, for example, by the auxiliary content determination module 122 provided by the target content determination module 114 of the DGGS 110 described with reference to FIGS. 2A and 2E using aspects of the presentation module 112 described with reference to FIG. 2F, including the auxiliary display generation module 256.

In the same or different embodiments the logic of operation 306 for disambiguating the one or more indicators of possible auxiliary content to determine a target content may include an operation 2117 whose logic specifies that determined target content is presented in an auxiliary window juxtaposed to the presented electronic content. The logic of operation 2117 may be performed, for example, by the advertisement determination module 242 provided by the auxiliary content determination module 122 provided by the target content determination module 114 of the DGGS 110 described with reference to FIGS. 2A and 2E using aspects of the presentation module 112 described with reference to FIG. 2F, including the auxiliary display generation module 256.

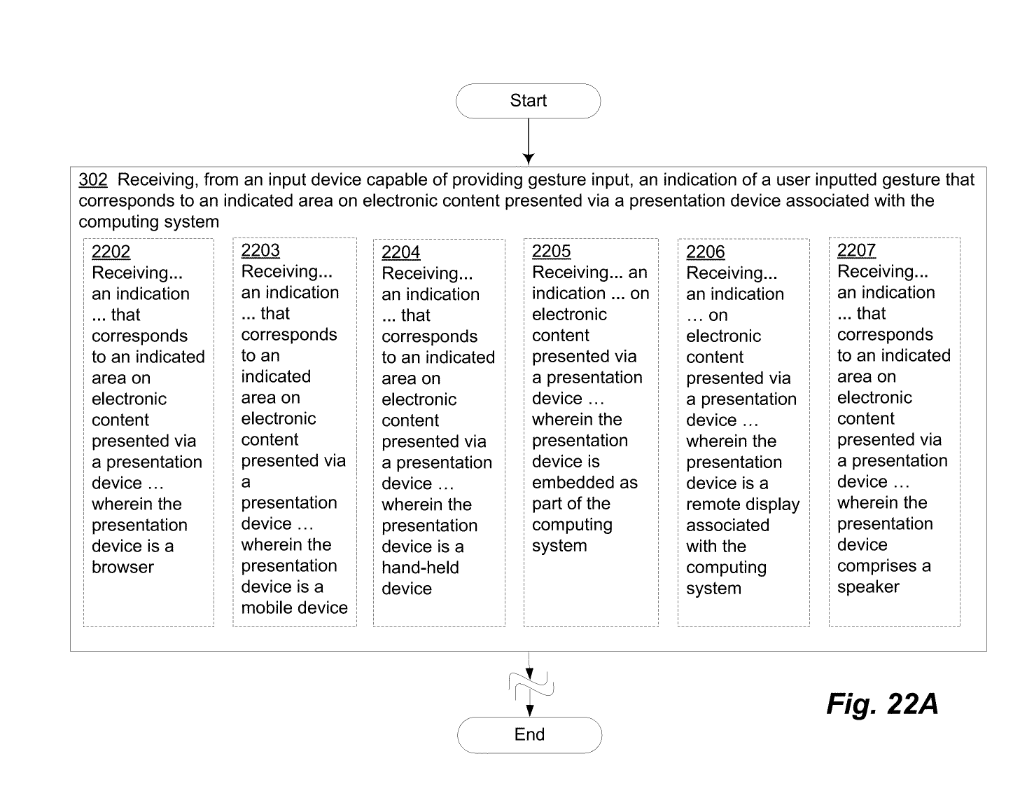

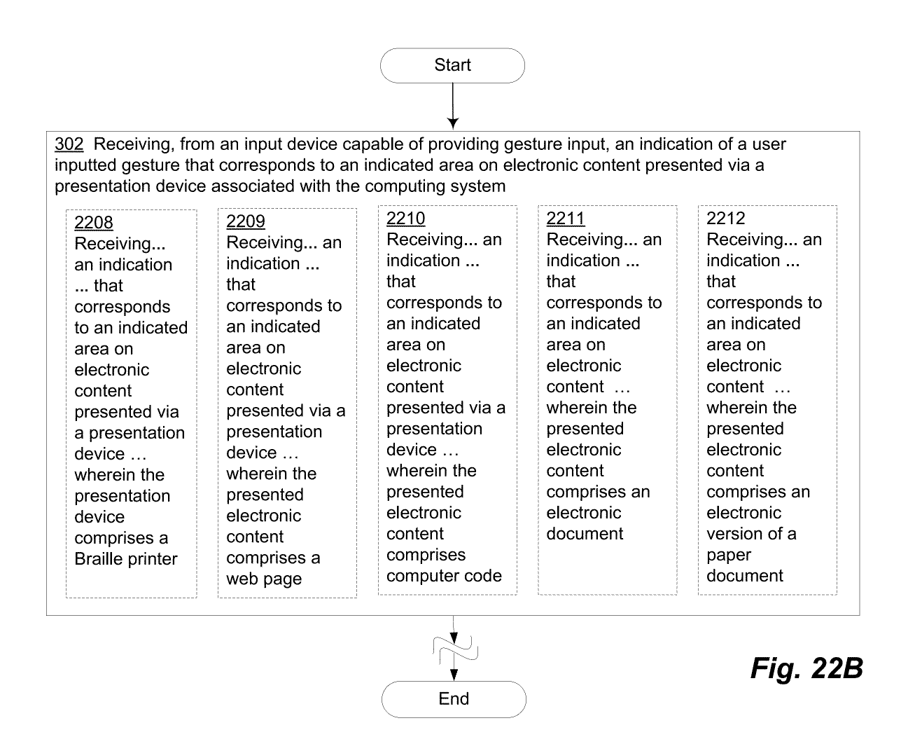

FIG. 22A is an example flow diagram of example logic illustrating various example embodiments of block 302 of FIG. 3. In the same or different embodiments, the logic of operation 302 for receiving, from an input device capable of providing gesture input, an indication of a user inputted gesture that corresponds to an indicated area on electronic content presented via a presentation device associated with the computing system may further include an operation 2202 whose logic specifies that the presentation device is a browser determined target content is presented in an auxiliary window juxtaposed to the presented electronic content. The logic of operation 2202 may be performed, for example, by the specific device handlers module 258 provided by the presentation module 112 of the DGGS 110 described with reference to FIGS. 2A and 2F.

In the same or different embodiments, the logic of operation 302 for receiving, from an input device capable of providing gesture input, an indication of a user inputted gesture that corresponds to an indicated area on electronic content presented via a presentation device associated with the computing system may further include an operation 2203 whose logic specifies that the presentation device is a mobile device determined target content is presented in an auxiliary window juxtaposed to the presented electronic content. The logic of operation 2202 may be performed, for example, by the specific device handlers module 258 provided by the presentation module 112 of the DGGS 110 described with reference to FIGS. 2A and 2F.

In the same or different embodiments, the logic of operation 302 for receiving, from an input device capable of providing gesture input, an indication of a user inputted gesture that corresponds to an indicated area on electronic content presented via a presentation device associated with the computing system may further include an operation 2204 whose logic specifies that the presentation device is a hand-held device determined target content is presented in an auxiliary window juxtaposed to the presented electronic content. The logic of operation 2204 may be performed, for example, by the specific device handlers module 258 provided by the presentation module 112 of the DGGS 110 described with reference to FIGS. 2A and 2F.

In the same or different embodiments, the logic of operation 302 for receiving, from an input device capable of providing gesture input, an indication of a user inputted gesture that corresponds to an indicated area on electronic content presented via a presentation device associated with the computing system may further include an operation 2205 whose logic specifies that the presentation device is embedded as part of the computing system determined target content is presented in an auxiliary window juxtaposed to the presented electronic content. The logic of operation 2205 may be performed, for example, by the specific device handlers module 258 provided by the presentation module 112 of the DGGS 110 described with reference to FIGS. 2A and 2F.

In the same or different embodiments, the logic of operation 302 for receiving, from an input device capable of providing gesture input, an indication of a user inputted gesture that corresponds to an indicated area on electronic content presented via a presentation device associated with the computing system may further include an operation 2206 whose logic specifies that the presentation device is a remote display associated with the computing system determined target content is presented in an auxiliary window juxtaposed to the presented electronic content. The logic of operation 2206 may be performed, for example, by the specific device handlers module 258 provided by the presentation module 112 of the DGGS 110 described with reference to FIGS. 2A and 2F.

In the same or different embodiments, the logic of operation 302 for receiving, from an input device capable of providing gesture input, an indication of a user inputted gesture that corresponds to an indicated area on electronic content presented via a presentation device associated with the computing system may further include an operation 2207 whose logic specifies that the presentation device comprises a speaker determined target content is presented in an auxiliary window juxtaposed to the presented electronic content. The logic of operation 2207 may be performed, for example, by the specific device handlers module 258 provided by the presentation module 112 of the DGGS 110 described with reference to FIGS. 2A and 2F, including the speaker device handler.

FIG. 22B is an example flow diagram of example logic illustrating various example embodiments of block 302 of FIG. 3. In the same or different embodiments, the logic of operation 302 for receiving, from an input device capable of providing gesture input, an indication of a user inputted gesture that corresponds to an indicated area on electronic content presented via a presentation device associated with the computing system may further include an operation 2208 whose logic specifies that the presentation device comprises a Braille printer determined target content is presented in an auxiliary window juxtaposed to the presented electronic content. The logic of operation 2208 may be performed, for example, by the specific device handlers module 258 provided by the presentation module 112 of the DGGS 110 described with reference to FIGS. 2A and 2F, including the Braille printer.

In the same or different embodiments, the logic of operation 302 for receiving, from an input device capable of providing gesture input, an indication of a user inputted gesture that corresponds to an indicated area on electronic content presented via a presentation device associated with the computing system may further include an operation 2209 whose logic specifies that the presented electronic content comprises a web page determined target content is presented in an auxiliary window juxtaposed to the presented electronic content. The logic of operation 2209 may be performed, for example, by the specific device handlers module 258 provided by the presentation module 112 of the DGGS 110 described with reference to FIGS. 2A and 2F, including the browser hander.

In the same or different embodiments, the logic of operation 302 for receiving, from an input device capable of providing gesture input, an indication of a user inputted gesture that corresponds to an indicated area on electronic content presented via a presentation device associated with the computing system may further include an operation 2210 whose logic specifies that the presented electronic content comprises computer code determined target content is presented in an auxiliary window juxtaposed to the presented electronic content. The logic of operation 2210 may be performed, for example, by the presentation module 112 of the DGGS 110 described with reference to FIGS. 2A and 2F.

In the same or different embodiments, the logic of operation 302 for receiving, from an input device capable of providing gesture input, an indication of a user inputted gesture that corresponds to an indicated area on electronic content presented via a presentation device associated with the computing system may further include an operation 2211 whose logic specifies that the presented electronic content comprises an electronic document determined target content is presented in an auxiliary window juxtaposed to the presented electronic content. The logic of operation 2210 may be performed, for example, by the presentation module 112 of the DGGS 110 described with reference to FIGS. 2A and 2F.

In the same or different embodiments, the logic of operation 302 for receiving, from an input device capable of providing gesture input, an indication of a user inputted gesture that corresponds to an indicated area on electronic content presented via a presentation device associated with the computing system may further include an operation 2212 whose logic specifies that the presented electronic content comprises an electronic version of a paper document determined target content is presented in an auxiliary window juxtaposed to the presented electronic content. The logic of operation 2212 may be performed, for example, by the presentation module 112 of the DGGS 110 described with reference to FIGS. 2A and 2F.

FIG. 23 is an example flow diagram of example logic illustrating various example embodiments of operations 302 to 308 of FIG. 3. In particular, the logic of the operations 302 to 308 may further include logic 2302 that specifics that the entire method is performed by a client. As described earlier, a client may be hardware, software, or firmware, physical or virtual, and may be part or the whole of a computing system. A client may be an application or a device.

In the same or different embodiments, the logic of the operations 302 to 308 may further include logic 2303 that specifics that the entire method is performed by a server. As described earlier, a server may be hardware, software, or firmware, physical or virtual, and may be part or the whole of a computing system. A server may be service as well as a system.

FIG. 24 is an example block diagram of a computing system for practicing embodiments of a Dynamic Gesturelet Generation System as described herein. Note that a general purpose or a special purpose computing system suitably instructed may be used to implement an DGGS, such as DGGS 110 of FIG. 1. Further, the DGGS may be implemented in software, hardware, firmware, or in some combination to achieve the capabilities described herein.

The computing system 100 may comprise one or more server and/or client computing systems and may span distributed locations. In addition, each block shown may represent one or more such blocks as appropriate to a specific embodiment or may be combined with other blocks. Moreover, the various blocks of the DGGS 110 may physically reside on one or more machines, which use standard (e.g., TCP/IP) or proprietary interprocess communication mechanisms to communicate with each other.

In the embodiment shown, computer system 100 comprises a computer memory (“memory”) 101, a display 2402, one or more Central Processing Units (“CPU”) 2403, Input/Output devices 2404 (e.g., keyboard, mouse, CRT or LCD display, etc.), other computer-readable media 2405, and one or more network connections 406. The DGGS 110 is shown residing in memory 101. In other embodiments, some portion of the contents, some of, or all of the components of the DGGS 110 may be stored on and/or transmitted over the other computer-readable media 2405. The components of the DGGS 110 preferably execute on one or more CPUs 2403 and manage providing automatic navigation to auxiliary content, as described herein. Other code or programs 2430 and potentially other data repositories, such as data repository 2420, also reside in the memory 101, and preferably execute on one or more CPUs 2403. Of note, one or more of the components in FIG. 24 may not be present in any specific implementation. For example, some embodiments embedded in other software may not provide means for user input or display.

In a typical embodiment, the DGGS 110 includes one or more input modules 111, one or more presentation modules 112, one or more criteria determination modules 115, one or more target content determination modules 114 and one or more automated navigation modules 113. In at least some embodiments, the persistent state data 41 is provided external to the DGGS 110 and is available, potentially, over one or more networks 30. Other and/or different modules may be implemented. In addition, the DGGS 110 may interact via a network 30 with application or client code 2455 that can absorb gesturelets, for example, for other purposes, one or more client computing systems or client devices 20*, and/or one or more third-party content provider systems 2465, such as third party advertising systems or other purveyors of auxiliary content. Also, of note, the history data repository 2415 may be provided external to the DGGS 110 as well, for example in a knowledge base accessible over one or more networks 30.

In an example embodiment, components/modules of the DGGS 110 are implemented using standard programming techniques. However, a range of programming languages known in the art may be employed for implementing such example embodiments, including representative implementations of various programming language paradigms, including but not limited to, object-oriented (e.g., Java, C++, C#, Smalltalk, etc.), functional (e.g., ML, Lisp, Scheme, etc.), procedural (e.g., C, Pascal, Ada, Modula, etc.), scripting (e.g., Perl, Ruby, Python, JavaScript, VBScript, etc.), declarative (e.g., SQL, Prolog, etc.), etc.

The embodiments described above may also use well-known or proprietary synchronous or asynchronous client-server computing techniques. However, the various components may be implemented using more monolithic programming techniques as well, for example, as an executable running on a single CPU computer system, or alternately decomposed using a variety of structuring techniques known in the art, including but not limited to, multiprogramming, multithreading, client-server, or peer-to-peer, running on one or more computer systems each having one or more CPUs. Some embodiments are illustrated as executing concurrently and asynchronously and communicating using message passing techniques. Equivalent synchronous embodiments are also supported by an DGGS implementation.

In addition, programming interfaces to the data stored as part of the DGGS 110 (e.g., in the data repositories 2415 and 2416) can be available by standard means such as through C, C++, C#, and Java APIs; libraries for accessing files, databases, or other data repositories; through scripting languages such as XML; or through Web servers, FTP servers, or other types of servers providing access to stored data. The repositories 2415 and 41 may be implemented as one or more database systems, file systems, or any other method known in the art for storing such information, or any combination of the above, including implementation using distributed computing techniques.

Also the example DGGS 110 may be implemented in a distributed environment comprising multiple, even heterogeneous, computer systems and networks. For example, in one embodiment, the components 111-115 are all located in physically different computer systems. In another embodiment, various modules of the DGGS 110 are hosted each on a separate server machine and may be remotely located from the tables which are stored in the data repositories 2414 and 41. Also, one or more of the modules may themselves be distributed, pooled or otherwise grouped, such as for load balancing, reliability or security reasons. Different configurations and locations of programs and data are contemplated for use with techniques of described herein. A variety of distributed computing techniques are appropriate for implementing the components of the illustrated embodiments in a distributed manner including but not limited to TCP/IP sockets, RPC, RMI, HTTP, Web Services (XML-RPC, JAX-RPC, SOAP, etc.) etc. Other variations are possible. Also, other functionality could be provided by each component/module, or existing functionality could be distributed amongst the components/modules in different ways, yet still achieve the functions of an DGGS.

Furthermore, in some embodiments, some or all of the components of the DGGS 110 may be implemented or provided in other manners, such as at least partially in firmware and/or hardware, including, but not limited to one or more application-specific integrated circuits (ASICs), standard integrated circuits, controllers (e.g., by executing appropriate instructions, and including microcontrollers and/or embedded controllers), field-programmable gate arrays (FPGAs), complex programmable logic devices (CPLDs), etc. Some or all of the system components and/or data structures may also be stored (e.g., as executable or other machine readable software instructions or structured data) on a computer-readable medium (e.g., a hard disk; a memory; a network; or a portable media article to be read by an appropriate drive or via an appropriate connection). Some or all of the components and/or data structures may be stored on tangible storage mediums. Some or all of the system components and data structures may also be transmitted in a non-transitory manner via generated data signals (e.g., as part of a carrier wave or other analog or digital propagated signal) on a variety of computer-readable transmission mediums, such as media 2405, including wireless-based and wired/cable-based mediums, and may take a variety of forms (e.g., as part of a single or multiplexed analog signal, or as multiple discrete digital packets or frames). Such computer program products may also take other forms in other embodiments. Accordingly, embodiments of this disclosure may be practiced with other computer system configurations.

From the foregoing it will be appreciated that, although specific embodiments have been described herein for purposes of illustration, various modifications may be made without deviating from the spirit and scope of the claims. For example, the methods and systems for performing automatic navigation to auxiliary content discussed herein are applicable to other architectures other than a windowed or client-server architecture. Also, the methods and systems discussed herein are applicable to differing protocols, communication media (optical, wireless, cable, etc.) and devices (such as wireless handsets, electronic organizers, personal digital assistants, tablets, portable email machines, game machines, pagers, navigation devices such as GPS receivers, etc.).

1. A method in a computing system for automatically providing navigation to target content comprising:
receiving, from an input device capable of providing gesture input, an indication of a user inputted gesture that corresponds to an indicated area on electronic content presented via a presentation device associated with the computing system;
determining, without selection of a link previously encoded with the presented electronic content, one or more indicators of possible auxiliary content to be presented, the determining based upon the indicated area on the presented electronic content and a set of criteria;
disambiguating the one or more indicators of possible auxiliary content to determine a target content; and
causing the determined target content to be presented via the presentation device.

2. The method of claim 1, further comprising:
generating a persistent state that represents the indicated area.

3. The method of claim 2 wherein generating a persistent state that represents the indicated area comprises generating a gesturelet.

4. The method of claim 2, further comprising:
in response to receiving notification of the persistent state that represents the indicated area, determining a target content to be presented and causing the determined target content to be presented.

5. The method of claim 2 wherein generating a persistent state that represents the indicated area comprises generating a uniform resource identifier.

6. The method of claim 1, further comprising:
generating a persistent state that represents the indicated area and associating the generated persistent state with the determined target content.

7. The method of claim 1, further comprising:
generating a persistent state that represents the indicated area and associating the generated persistent state with an advertisement.

8. The method of claim 7 wherein the advertisement is supplied by an entity other than an entity associated with the presented electronic content.

9. The method of claim 7 wherein the advertisement is supplied by an entity that competes against an entity associated with the presented electronic content.

10. The method of claim 7 wherein the advertisement is selected from a plurality of advertisements.

11. The method of claim 7 wherein the advertisement is supplied by an entity associated with the presented electronic content.

12. The method of claim 1, further comprising:
generating a persistent state that represents the indicated area and associating the generated persistent state with an opportunity for commercialization.

13. The method of claim 12 wherein the opportunity for commercialization is at least one of an advertisement, interactive entertainment, a role-playing game, a computer-assisted competition, and/or a bidding opportunity.

14.-17. (canceled)

18. The method of claim 1, further comprising:
generating a persistent state that represents the indicated area and associating the generated persistent state with supplemental information to the presented electronic content.

19. The method of claim 18 wherein generating a persistent state that represents the indicated area and associating the generated persistent state with supplemental information to the presented electronic content comprises generating a uniform resource identifier.

20. The method of claim 1, further comprising:
generating a persistent state that represents the indicated area and associating the generated persistent state with a purchase and/or an offer.

21. The method of claim 20 wherein the purchase and/or offer is for at least one of information, an item for sale, a service for offer, a service for sale, a prior purchase of the user, a current purchase, and/or a purchase of an entity that is part of a social network of the user.

22.-26. (canceled)

27. The method of claim 1 wherein the user inputted gesture approximates at least one of a circle shape, an oval shape, a closed path, and/or a polygon.

28.-30. (canceled)

31. The method of claim 1 wherein the user inputted gesture is an audio gesture.

32. The method of claim 31 wherein the audio gesture is at least one of a spoken word or phrase and/or a direction.

33. (canceled)

34. The method of claim 1 wherein the input device is at least one of a mouse, a touch sensitive display, a wireless device, a human body part, a microphone, a stylus, and/or a pointer.

35. The method of claim 1 wherein the indicated area on the presented electronic content includes at least a word or a phrase.

36. The method of claim 1 wherein the indicated area on the presented electronic content includes at least a graphical object, image, and/or icon.

37. The method of claim 1 wherein the indicated area on the presented electronic content includes an utterance.

38. The method of claim 1 wherein the indicated area comprises non-contiguous parts.

39. The method of claim 1 wherein the set of criteria includes context of other text, audio, graphics, and/or objects within the presented electronic content.

40. The method of claim 1 wherein the set of criteria includes an attribute of the gesture.

41. The method of claim 40 wherein the attribute of the gesture is at least one of a size of the gesture, a direction of the gesture, a color, and/or a measure of steering of the gesture.

42.-46. (canceled)

47. The method of claim 1 wherein the set of criteria includes prior history associated with the user.

48. The method of claim 47 wherein the prior history associated with the user includes at least one of prior search history, prior navigation history, prior purchase history, and/or demographic information associated with the user.

49.-54. (canceled)

55. The method of claim 47 wherein the prior history associated with the user is used to disambiguate the one or more indicators of possible auxiliary content to determine the target content.

56. The method of claim 1 wherein disambiguating the one or more indicators of possible auxiliary content to determine a target content further comprises:
disambiguating the one or more indicators of possible auxiliary content to determine the target content by presenting the one or more indicators of possible auxiliary content and receiving a selected indicator to one of the presented one or more indicators to determine the target content.

57. The method of claim 1 wherein disambiguating the one or more indicators of possible auxiliary content to determine a target content further comprises:
disambiguating the one or more indicators of possible auxiliary content by determining a default target content to be presented.

58. The method of claim 57 wherein the default target content may be overridden by the user.

59. The method of claim 1 wherein disambiguating the one or more indicators of possible auxiliary content to determine a target content further comprises:
disambiguating the one or more indicators of possible auxiliary content to determine a target content utilizing syntactic and/or semantic rules to aid in determining the target content.

60. The method of claim 1 wherein the determined target content comprises target content that corresponds to each of the one or more indicators of possible auxiliary content and wherein multiple target contents are presented.

61. The method of claim 1 wherein the determined target content is presented as an overlay on top of the presented electronic content.

62. (canceled)

63. The method of claim 61 wherein the overlay is made visible by causing a pane to appear as though the pane is caused to slide from one side of the presentation device onto the presented electronic content.

64. The method of claim 1 wherein the determined target content includes at least one advertisement.

65. The method of claim 64 wherein the advertisement is provided by at least one of an entity separate from the entity that provided the presented electronic content, a competitor entity, and/or an entity associated with the presented electronic content.

66. (canceled)

67. The method of claim 64 wherein the advertisement is selected from a plurality of advertisements.

68. (canceled)

69. The method of claim 1 wherein the determined target content includes supplemental information.

70. The method of claim 1 wherein the determined target content is presented in an auxiliary window, pane, frame, or other auxiliary display construct.

71. (canceled)

72. The method of claim 1 wherein the presentation device is at least one of a browser, a mobile device, a hand-held device, embedded as part of the computing system, a remote display associated with the computing system, a speaker, or a Braille printer.

73.-78. (canceled)

79. The method of claim 1 wherein the presented electronic content comprises at least one of computer code, a web page, an electronic document, an electronic version of a paper document.

80.-82. (canceled)

83. The method of claim 1 performed by a client or by a server.

84.-232. (canceled)
